(19) United States
(12) Patent Application Publication
(10) Pub. No.: US 2026/0322857 A1
(43) Pub. Date: Oct. 15, 2026

(54) INFORMATION PROCESSING APPARATUS, INFORMATION PROCESSING METHOD, AND RECORDING MEDIUM

(71) Applicant: SONY SEMICONDUCTOR SOLUTIONS CORPORATION, KANAGAWA (JP)

(72) Inventors: Hideki ANDO, KANAGAWA (JP); Hironori MIYOSHI, KANAGAWA (JP)

(21) Appl. No.: 19/113,658

(22) PCT Filed: Sep. 11, 2023
(86) PCT No.: PCT/JP2023/032951

§ 371 Date: Mar. 20, 2025

(30) Foreign Application Priority Data
Sep. 28, 2022 (JP) 2022-155345

(51) Int. Cl. H04L 9/40

(52) U.S. Cl. CPC H04L 63/20; H04L 63/101

(57) ABSTRACT

The present disclosure relates to an information processing apparatus, an information processing method, and a recording medium that enable an apparatus interposed between a device and an application apparatus to appropriately provide data from the device to the application apparatus.

A DS includes: a control unit that acquires, for a plurality of App apparatuses, association information between a device that outputs data and each App apparatus that performs predetermined data processing using the data, determines a destination of the data acquired from one or more of the devices, based on the acquired association information, and controls transmission of the data to one or more of the App apparatuses determined as the destination. The technology of the present disclosure can be applied to, for example, apparatuses that perform data communication in accordance with the NICE standard.

### TECHNICAL FIELD

The present disclosure relates to an information processing apparatus, an information processing method, and a recording medium, and particularly to an information processing apparatus, an information processing method, and a recording medium that enable an apparatus interposed between a device and an application apparatus to appropriately provide data from the device to the application apparatus.

### BACKGROUND ART

A standard called the Network of Intelligent Camera Ecosystem (NICE) has been established with the aim of building an interface between a device (a sensor device) such as a surveillance camera and an application apparatus (a service server) that processes data obtained by the device to provide a predetermined service. In addition, technologies related to devices or application apparatuses that can be applied to the NICE standard have recently been proposed (e.g., see PTL 1).

In a system that complies with the NICE standard, a relay apparatus called a data service (hereinafter referred to as DS) may be interposed between a device and an application apparatus. The DS serves as a subcontractor for the application apparatus to communicate with the device on behalf of the application apparatus.

### CITATION LIST

### Patent Literature

### PTL 1

WO 2022/004412

### SUMMARY

### Technical Problem

The NICE standard assumes a one-to-one relationship between a DS and an application apparatus. However, a DS may serve as an intermediary between a plurality of application apparatuses. When a DS is to operate as a subcontractor for a plurality of application apparatuses, the current NICE standard cannot inform the DS of device access authorities that differ for each of the application apparatuses. Therefore, the DS, which serves as a subcontractor for the application apparatuses, does not know to which application apparatus the DS is permitted to provide data from the device.

The present disclosure has been made in view of the above circumstances, and enables an apparatus interposed between a device and an application apparatus to appropriately provide data from the device to the application apparatus.

### Solution to Problem

An information processing apparatus according to a first aspect of the present disclosure includes a control unit that acquires, for a plurality of application apparatuses, association information between a device that outputs data and each of the application apparatuses that performs predetermined data processing using the data, determines a destination of the data acquired from one or more of the devices, based on the acquired association information, and controls transmission of the data to one or more of the application apparatuses determined as the destination.

An information processing method according to a first aspect of the present disclosure includes: by an information processing apparatus, acquiring, for a plurality of application apparatuses, association information between a device that outputs data and each of the application apparatuses that performs predetermined data processing using the data; determining a destination of the data acquired from one or more of the devices, based on the acquired association information; and transmitting the data to one or more of the application apparatuses determined as the destination.

A recording medium according to a first aspect of the present disclosure is a computer-readable recording medium having stored thereon a program for causing a computer to execute processing of: acquiring, for a plurality of application apparatuses, association information between a device that outputs data and each of the application apparatuses that performs predetermined data processing using the data; determining a destination of the data acquired from one or more of the devices, based on the acquired association information; and transmitting the data to one or more of the application apparatuses determined as the destination.

In the first aspect of the present disclosure, for a plurality of application apparatuses, association information between a device that outputs data and each of the application apparatuses that performs predetermined data processing using the data is acquired, a destination of the data acquired from one or more of the devices, based on the acquired association information is determined, and the data is transmitted to one or more of the application apparatuses determined as the destination.

An information processing apparatus according to a second aspect of the present disclosure includes a control unit that controls transmission of an identifier for identifying a role of a TLS client or a TLS server and a TLS certificate in accordance with the identifier to two entities that communicate data generated by a device.

An information processing method according to a second aspect of the present disclosure includes, by an information processing apparatus, transmitting an identifier for identifying a role of a TLS client or a TLS server and a TLS certificate in accordance with the identifier to two entities that communicate data generated by a device.

A recording medium according to a second aspect of the present disclosure is a computer-readable recording medium having stored thereon a program causing a computer to execute processing of transmitting an identifier for identifying a role of a TLS client or a TLS server and a TLS certificate in accordance with the identifier to two entities that communicate data generated by a device.

In the second aspect of the present disclosure, an identifier for identifying a role of a TLS client or a TLS server and a TLS certificate in accordance with the identifier are transmitted to two entities that communicate data generated by a device.

The communication may include not only wireless communication and wired communication, but also a mixture of wireless communication and wired communication, that is, wireless communication in some sections and wired communication in other sections. Communication from one apparatus to another apparatus may be performed by wired communication, and communication from the other apparatus to the one apparatus may be performed by wireless communication.

The information processing apparatus according to each of the first and second aspects of the present disclosure can be realized by causing a computer to execute a program. The program to be executed by the computer to realize this information processing apparatus can be provided by being transmitted via a transmission medium or by being recorded on a recording medium.

The information processing apparatus may be an independent apparatus or may be an internal block constituting a single apparatus.

### BRIEF DESCRIPTION OF DRAWINGS

FIG. 1 is a diagram illustrating access control in the NICE Version 1.0.1.

FIG. 2 is a diagram illustrating access control in the NICE Version 1.0.1 when a DS is interposed.

FIG. 3 is a diagram illustrating access control in the NICE Version 1.1.

FIG. 4 is a diagram illustrating a basic operation sequence in the NICE Version 1.0.1 standard.

FIG. 5 is a block diagram illustrating a desired configuration example of a data processing system.

FIG. 6 is a block diagram illustrating the desired configuration example of the data processing system.

FIG. 7 is a block diagram illustrating the desired configuration example of the data processing system.

FIG. 8 is a block diagram illustrating a configuration example of a data processing system according to a first embodiment of the present disclosure.

FIG. 9 is a diagram illustrating an overview of a first access control method for the NICE Version 1.0.1.

FIG. 10 is a flowchart illustrating first access control processing for the NICE Version 1.0.1.

FIG. 11 illustrates an example of an AppControl object in step S51 of FIG. 10.

FIG. 12 illustrates an example of an access information issue request command in step S52 of FIG. 10.

FIG. 13 illustrates an example of an AppControl object in step S54 of FIG. 10.

FIG. 14 illustrates an example of the AppControl object in step S51 of FIG. 10.

FIG. 15 illustrates an example of a DeviceControl object in step S51 of FIG. 10.

FIG. 16 illustrates an example of the DeviceControl object in step S51 of FIG. 10.

FIG. 17 illustrates an example of a DeviceControl object in step S55 of FIG. 10.

FIG. 18 illustrates an example of a SceneMark object in step S58 of FIG. 10.

FIG. 19 illustrates an example of a DataSection object in step S58 of FIG. 10.

FIG. 20 is a diagram illustrating an overview of a first access control method for the NICE Version 1.1.

FIG. 21 is a flowchart illustrating first access control processing for the NICE Version 1.1.

FIG. 22 illustrates an example of GetSceneMode in step S87 of FIG. 21.

FIG. 23 is a diagram illustrating an overview of a second access control method for the NICE Version 1.0.1.

FIG. 24 is a flowchart illustrating second access control processing for the NICE Version 1.0.1.

FIG. 25 illustrates an example of a DeviceList object in step S122 of FIG. 24.

FIG. 26 is a diagram illustrating an overview of a second access control method for the NICE Version 1.1.

FIG. 27 is a flowchart illustrating second access control processing for the NICE Version 1.1.

FIG. 28 is a diagram illustrating a first access control method in the NICE Version 1.0.1 when two DSs are interposed.

FIG. 29 is a diagram illustrating a first access control method in the NICE Version 1.1 when two DSs are interposed.

FIG. 30 is a diagram illustrating a second access control method in the NICE Version 1.0.1 when two DSs are interposed.

FIG. 31 is a diagram illustrating a second access control method in the NICE Version 1.1 when two DSs are interposed.

FIG. 32 illustrates the source of access information and operation instruction information in FIG. 28 to FIG. 31.

FIG. 33 illustrates an example of a SceneMode object when two DSs are interposed.

FIG. 34 is a diagram illustrating a data pipeline.

FIG. 35 is a block diagram illustrating a configuration example of a data processing system according to a second embodiment of the present disclosure.

FIG. 36 is a diagram illustrating a certificate issue function of a management server.

FIG. 37 is a diagram illustrating distribution of TLS certificates to entities.

FIG. 38 is a flowchart illustrating authentication processing performed by the data processing system according to the second embodiment.

FIG. 39 is a diagram illustrating another example of a data pipeline.

FIG. 40 is a diagram for illustrating distribution of TLS certificates when two-way data communication is performed between devices.

FIG. 41 is a block diagram illustrating a configuration example of a device.

FIG. 42 is a block diagram illustrating a configuration example of computer hardware.

### DESCRIPTION OF EMBODIMENTS

Modes for embodying the technology of the present disclosure (hereinafter referred to as “embodiments”) will be described below with reference to the accompanying drawings. In the present specification and the drawings, components having substantially the same functional configuration will be denoted by the same reference numerals, and thus repeated descriptions thereof will be omitted. The description will be made in the following order.
1. Access Control Processing of NICE Standard
2. Desired System Configuration
3. Data Processing System According to First Embodiment
4. First Access Control Method (for NICE Version 1.0.1)
5. First Access Control Method (for NICE Version 1.1)
6. Second Access Control Method (for NICE Version 1.0.1)
7. Second Access Control Method (for NICE Version 1.1)
8. Case Where Plurality of DSs Are Interposed
9. Summary of Data Processing System According to First Embodiment
10. Data Processing System According to Second Embodiment
11. Flowchart of Authentication Processing
12. Summary of Data Processing System According to Second Embodiment
13. Hardware Configuration Example

### 1. Access Control Processing of NICE Standard

A data processing system of the present disclosure includes controls that grant access authorities that cannot be achieved with control compliant to the current NICE standard. Before describing the data processing system of the present disclosure, access control compliant to the current NICE standard will be described. There are currently at least two versions of the NICE standard: Version 1.0.1 and Version 1.1.

### NICE Version 1.0.1 (without DS)

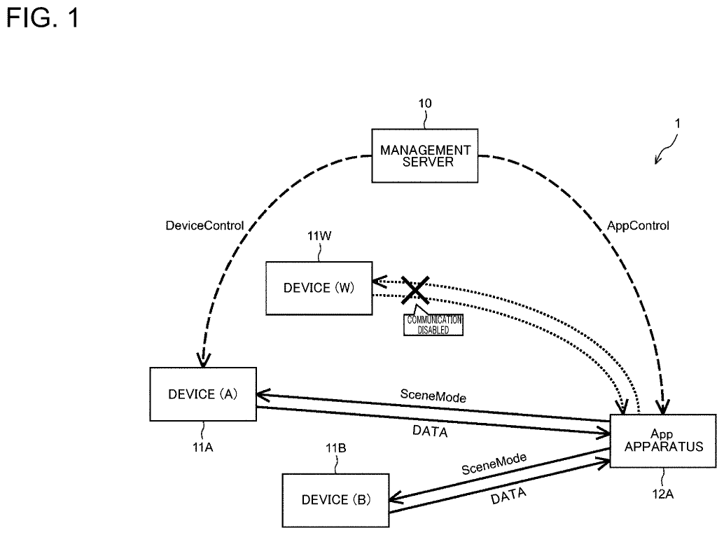

FIG. 1 is a diagram illustrating access control in the NICE Version 1.0.1.

A data processing system 1 illustrated in FIG. 1 includes a management server 10, a plurality of devices 11, and a plurality of App apparatuses 12. With regard to the devices 11 and App apparatuses 12, for the sake of convenience, FIG. 1 illustrates only three devices 11A, 11B, and 11W and one App apparatus 12A. The management server 10, the devices 11, and the App apparatuses 12 each constitute an entity of the data processing system 1.

The management server 10 is a server apparatus that performs access control for each of the plurality of devices 11 and each of the plurality of App apparatuses 12, which are arranged on a specified network, by appropriately granting access authority to each user for each of the devices 11 and the App apparatuses 12. Specifically, the management server 10 manages the devices 11 and the App apparatuses 12 in association with user accounts, and controls the device 11 and the App apparatus 12 that are associated with a specific user so that they can exchange data, while controlling the device 11 and the App apparatus 12 that belong to different users so that they cannot exchange data.

For example, when the device 11A and the device 11B and the App apparatus 12A are on a network as devices that are associated with a specific user A, the management server 10 controls the App apparatus 12A so that it can access and transmit and receive data to and from the device 11A and the device 11B of the same user, but controls the App apparatus 12A so that it cannot access and transmit and receive data to and from the device 11W of another user W. In the NICE Version 1.0.1, the management server 10 corresponds to, for example, a NICE license authority and NICE account service (LA/AS). As the network, whether wired or wireless, for example, a public telephone line network, a wide area communication network for wireless mobile devices such as a so-called 4G network or 5G network, a wide area network (WAN), a local area network (LAN), the Internet, a home network, a satellite communication network, and the like can be used.

The device 11 is configured as an apparatus including sensors such as: an image sensor such as a surveillance camera, a ToF sensor, an infrared (IR) camera, a positioning sensor such as a Global Navigation Satellite System (GNSS) sensor, a temperature sensor, a sound collection apparatus (microphone), an air pressure sensor, a humidity sensor, a wind direction and wind speed sensor, a sunshine sensor, a precipitation sensor, a water level sensor, and a seismic intensity sensor (a sensor for detecting the seismic intensity of an earthquake). The device 11 transmits to the corresponding App apparatus 12 data acquired by the sensors directly, or data after performing predetermined data processing by an arithmetic apparatus such as a central processing unit (CPU) or a microprocessing unit (MPU), which is built-in, or an integrated circuit such as an application specific integrated circuit (ASIC) or a field-programmable gate array (FPGA). The ToF sensor is a sensor that directly or indirectly measures the return time of reflected light from a subject to acquire shape information (depth information/image) such as the distance between the ToF sensor and the subject and unevenness. The device 11 may be installed fixedly like a surveillance camera installed at home or a store, or may be mounted on a moving body and installed so as to be movable anywhere. Examples of the moving body include automobiles, electric vehicles, hybrid electric vehicles, motorcycles, bicycles, personal mobility, airplanes, drones, ships, robots (mobile robots), construction machines, and agricultural machines (tractors).

The App apparatus 12 is an apparatus (application apparatus) that has hardware such as a central processing unit (CPU), a read only memory (ROM), and a random access memory (RAM) and executes an application (program) that performs predetermined data processing using data transmitted from the device 11. The App apparatus 12 may be, for example, a server apparatus, a mobile terminal such as a smartphone, a tablet personal computer (PC), a smart watch, a mobile phone, a laptop PC, or a notebook PC, or a wearable device such as a head mounted display (HMD). The App apparatus 12 may also be an electronic control unit (ECU) mounted on a vehicle, or a controller that remotely controls a drone or a robot. Furthermore, the App apparatus 12 may include a display unit (not illustrated) that displays to the user, an operation unit (not illustrated) that receives operations from the user, a speaker (not illustrated) that outputs sound to the user, and the like. In the NICE Version 1.0.1, the App apparatus 12 is called an App or a Service.

Referring to FIG. 1, access control in the NICE Version 1.0.1 will be described as an example of the access control for the device 11A and the device 11B and the App apparatus 12A, which are associated with the specific user A.

The management server 10 manages the devices 11 and the App apparatus(es) 12 in association with the user accounts of the users, and manages, for each device 11, the App apparatus(es) 12 that can use the device 11. With the account of the user A, the devices 11A and 11B and the App apparatus 12A are associated, and the App apparatus 12A is registered as an App apparatus 12 that can use the devices 11A and 11B.

The management server 10 transmits an AppControl object in response to a request from the App apparatus 12A, thereby transmitting to the App apparatus 12A access point information related to the devices 11A and 11B, which is used when the App apparatus 12A connects to the devices 11A and 11B. This access point information includes a device ID (UUID) for identifying the device 11 which is the communication partner, public key information, an access token, and the like. The access token includes source information (sub: subject) and destination information (aud: audience). Specifically, the access point information related to the device 11A includes the device ID and public key information of the device 11A, the source (sub) of the access token is the App apparatus 12A, and the destination (aud) is the device 11A. The access point information related to the device 11B includes the device ID and public key information of the device 11B, the source (sub) of the access token is the App apparatus 12A, and the destination (aud) is the device 11B.

In the NICE standard, each of the devices 11 and the App apparatuses 12 is composed of a collection of one or more nodes, and the level of access point information (connection information) is classified into three classes: Management I/F (Interface), Control I/F, and Data I/F. Management I/F is a class level for issuing instructions to all the devices 11 or all the App apparatuses 12, and can include access point information of Control I/F and Data I/F. Control I/F is a class for issuing an instruction to a node, and includes access point information for Control I/F on a per-node basis. Data I/F is a class level for issuing an instruction related to data, and includes access point information related to one or more ports of Data I/F on a per-node basis. The port is a concept that indicates the communication destination of Data I/F, and each node can have a plurality of ports.

The management server 10 transmits a DeviceControl object to the device 11A, thereby transmitting to the device 11A access point information related to the App apparatus 12A, which is used when the device 11A connects to the App apparatus 12A. The access point information related to the App apparatus 12A includes the device ID and public key information of the App apparatus 12A, and the source (sub) of the access token is the device 11A, and the destination (aud) is the App apparatus 12A. Although not illustrated in the figure, similarly for the device 11B, the management server 10 transmits access point information related to the App apparatus 12A to the device 11B by using a DeviceControl object. The access point information related to the App apparatus 12A includes the device ID and public key information of the App apparatus 12A, and the source (sub) of the access token is the device 11B, and the destination (aud) is the App apparatus 12A. The DeviceControl object includes access point information for Control I/F of the App apparatus 12A, but does not include access point information for Data I/F. The access point information for Data I/F is included in a SceneMode object, which will be described later.

Since the AppControl object transmitted from the management server 10 to the App apparatus 12A does not include access point information related to the device 11W associated with another user, the App apparatus 12A cannot access the device 11W. The DeviceControl object provided to the device 11W also does not include access point information related to the App apparatus 12A. If the App apparatus 12A attempts to access the device 11W, the device 11W will reject communication with the App apparatus 12A.

Next, the App apparatus 12A communicates with the device 11A by using the access point information related to the device 11A acquired from the management server 10, and transmits a SceneMode object to the device 11A to specify data destination information and the like. The SceneMode object is an object for setting a scene mode as operation instruction information. The device 11A transmits data acquired by executing an operation set in the scene mode to the App apparatus 12A by using the access point information for Data I/F included in the SceneMode object. The source (sub) of the access token of the access point information for Data I/F is the device 11A, and the destination (aud) is the App apparatus 12A. Similarly for the device 11B, the App apparatus 12A transmits a SceneMode object to the device 11B to specify data destination information and the like.

As described above, in the NICE Version 1.0.1, the source (sub) and destination (aud) are specified by the AppControl object, the DeviceControl object, and the SceneMode object based on the appropriate association information between the device 11 and the App apparatus 12 held by the management server 10, so that access is controlled. The AppControl object, the DeviceControl object, and the SceneMode object are application programming interface (API) objects that can be acquired from an information provider by transmitting a request requesting setting information to the information provider.

### NICE Version 1.0.1 (with DS)

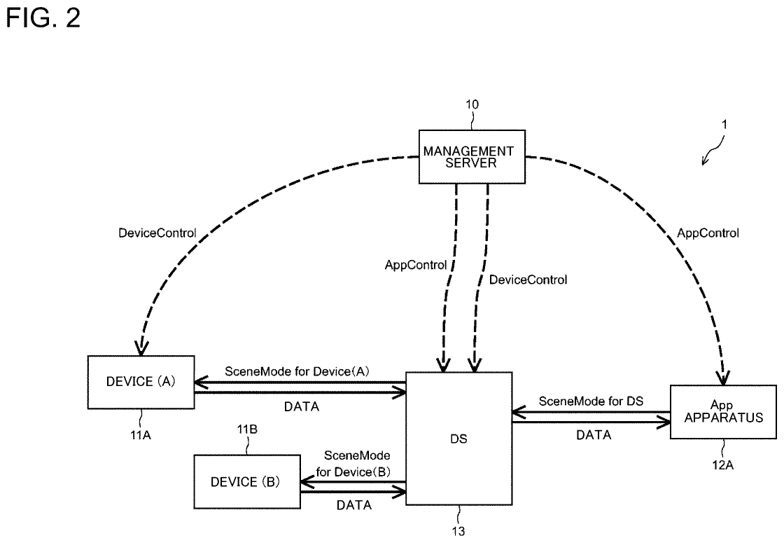

In the NICE Version 1.0.1, as illustrated in FIG. 2, a DS 13 may be interposed between the devices 11 and the App apparatus 12. The DS 13 is one of the entities of the data processing system 1, manages a plurality of devices 11, and serves as a subcontractor for the App apparatus 12. In such a case where there are a plurality (a large number) of devices 11 associated with the App apparatus 12, the DS 13 being interposed eliminates the need for the App apparatus 12 to access the devices 11 individually. The DS 13 is called Data Service in the NICE Version 1.0.1.

Referring to FIG. 2, access control in the NICE Version 1.0.1 when the DS 13 is interposed will be described.

The management server 10 transmits an AppControl object in response to a request from the App apparatus 12, thereby transmitting to the App apparatus 12 access point information related to the DS 13, which is used when the App apparatus 12 connects to the DS 13. The access point information includes a device ID (UUID) for identifying the DS 13 which is the communication partner, public key information, an access token, and the like. The source (sub) of this access token is the App apparatus 12A, and the destination (aud) is the DS 13.

The DS 13 behaves, with respect to the devices 11A and 11B on the downstream (network edge side), as an entity corresponding to an App apparatus 12 between two of the device 11 and the App apparatus 12 illustrated in FIG. 1. On the other hand, the DS 13 behaves, with respect to the App apparatus 12A on the upstream (network cloud side), as an entity corresponding to a device 11 between two of the device 11 and the App apparatus 12 illustrated in FIG. 1.

Specifically, an AppControl object for performing processing as an entity corresponding to the App apparatus 12A is transmitted from the management server 10 to the DS 13 in response to a request from the DS 13. The AppControl object includes access point information for the device 11A and access point information for the device 11B. The access point information for the device 11A includes a device ID for identifying the device 11A which is the communication partner, public key information, an access token, and the like. The source (sub) of the access token for the device 11A is the DS 13, and the destination (aud) is the device 11A. The access point information for the device 11B includes a device ID for identifying the device 11B which is the communication partner, public key information, an access token, and the like. The source (sub) of the access token for the device 11B is the DS 13, and the destination (aud) is the device 11B.

A DeviceControl object for performing processing as an entity corresponding to the device 11 is transmitted from the management server 10 to the DS 13. The DeviceControl object includes the device ID and public key information of the App apparatus 12A, the source (sub) of the access token is the DS 13, and the destination (aud) is the App apparatus 12A.

Furthermore, the management server 10 transmits a DeviceControl object to the device 11A, thereby transmitting to the device 11A access point information related to the DS13, which is used when the device 11A connects to the DS13. The access point information related to the DS13 for the device 11A includes the device ID and public key information of the DS13, the source (sub) of the access token is the device 11A, and the destination (aud) is the DS13. Although not illustrated in the figure, similarly for the device 11B, the management server 10 transmits access point information related to the DS13 to the device 11B by using the DeviceControl object. The access point information related to the DS13 for the device 11B includes the device ID and public key information of the DS13, the source (sub) of the access token is the device 11B, and the destination (aud) is the DS13.

The DS 13 communicates with the device 11A by using the access point information related to the device 11A acquired from the management server 10, and transmits a SceneMode object to the device 11A to specify data destination information and the like. The DS 13 also communicates with the device 11B by using the access point information related to the device 11B acquired from the management server 10, and transmits a SceneMode object to the device 11B to specify data destination information and the like.

The device 11A transmits to the DS 13 data acquired by executing an operation set in the scene mode by using the access point information for Data I/F included in the SceneMode object. The device 11B transmits to the DS 13 data acquired by executing an operation set in the scene mode by using the access point information for Data I/F included in the SceneMode object. The DS 13 transmits data acquired from the device 11A or the device 11B to the App apparatus 12A by using the access point information for Data I/F included in the SceneMode object.

As described above, when the DS 13 is interposed, the same access control as that for between the device 11 and the App apparatus 12 described above is performed for between the device 11 and the DS 13 and between the DS 13 and the App apparatus 12. The data acquired by the device 11A is transferred in the following order: from the device 11A to the DS 13, and from the DS 13 to the App apparatus 12A. The data acquired by the device 11B is transferred in the following order: from the device 11B to the DS 13, and from the DS 13 to the App apparatus 12A. A series of data flows through the DS 13, such as device 11A—DS 13—App apparatus 12A or device 11B—DS 13—App apparatus 12A, is called a data pipeline.

As described above, in the NICE Version 1.0.1, an AppControl object or a DeviceControl object is transmitted from the management server 10 to the devices 11A and 11B, the App apparatus 12A, and the DS 13, and a SceneMode object is transmitted from the App apparatus 12A or the DS 13, which is a higher-level entity.

In communication between the device 11 and the App apparatus 12 in FIG. 1, between the device 11 and the DS 13 or between the DS 13 and the App apparatus 12 in FIG. 2, a broker (e.g., an MQTT broker) may be interposed between the two.

### NICE Version 1.1

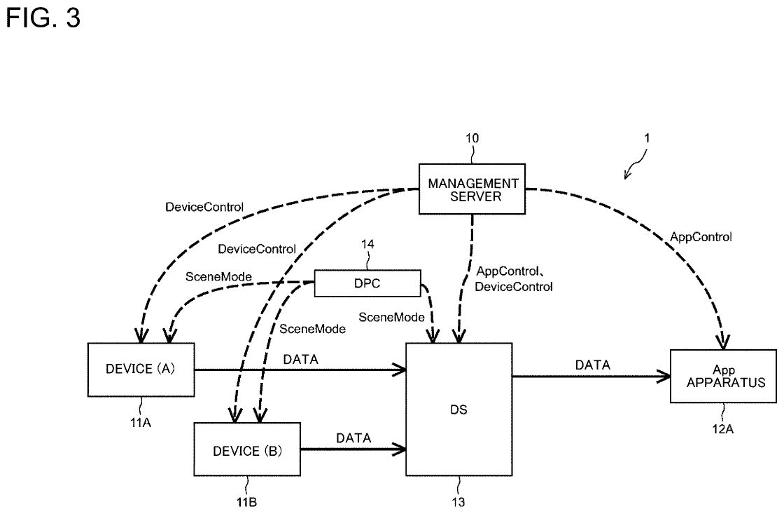

Next, referring to FIG. 3, access control in the NICE Version 1.1 will be described as an example of the access control for the device 11A and the device 11B and the App apparatus 12A, which are associated with the specific user A, similarly to the example described above.

In the NICE Version 1.1, the DS 13 is always present. In addition, in the NICE Version 1.1, a data pipeline controller (DPC) 14 that manages (controls) a data pipeline is newly added to the data processing system 1.

The management server 10 manages the devices 11 and the App apparatuses 12 in association with user accounts. However, the management server 10 does not have information in which a device 11 and an App apparatus 12 are directly associated with each other for a specific user.

The DPC 14 has information related to data processing by acquiring necessary information from the management server 10 and the App apparatus 12A. For example, the DPC 14 has data pipeline information of device 11A—DS 13—App apparatus 12A and device 11B—DS 13—App apparatus 12A, and setting information for transmitting a SceneMode object acquired from the management server 10 or the App apparatus 12A.

The management server 10 transmits an AppControl object in response to a request from the App apparatus 12A, thereby transmitting to the App apparatus 12A access point information related to the DS 13, which is used when the App apparatus 12A connects to the DS 13. This access point information includes a device ID for identifying the DS 13 which is the communication partner, public key information, an access token, and the like. The source (sub) of this access token is the App apparatus 12A, and the destination (aud) is the DS 13.

The management server 10 also transmits a DeviceControl object in response to a request from the device 11A, thereby transmitting to the device 11A access point information related to the DPC 14, which is used when the device 11A connects to the DPC 14. The access point information related to the DPC 14 for the device 11A includes the device ID and public key information of the DPC 14, the source (sub) of the access token is the device 11A, and the destination (aud) is the DPC 14. Similarly for the device 11B, the management server 10 transmits a DeviceControl object, thereby transmitting access point information related to the DPC 14 to the device 11B. The access point information related to the DPC 14 for the device 11B includes the device ID and public key information of the DPC 14, the source (sub) of the access token is the device 11B, and the destination (aud) is the DPC 14. In the NICE Version 1.0.1, the DeviceControl object can be transmitted in response to a request from each device 61, or can be transmitted without a request, but in the NICE Version 1.1, the DeviceControl object is always transmitted in response to a request from each device 61.

The management server 10 transmits an AppControl object for performing processing as corresponding to the App apparatus 12 to the DS 13 in response to a request from the DS 13. The AppControl object includes access point information for the device 11A and access point information for the device 11B. The access point information for the device 11A includes a device ID for identifying the device 11A which is the communication partner, public key information, an access token, and the like. The source (sub) of the access token for the device 11A is the DS 13, and the destination (aud) is the device 11A. The access point information for the device 11B includes a device ID for identifying the device 11B which is the communication partner, public key information, an access token, and the like. The source (sub) of the access token for the device 11B is the DS 13, and the destination (aud) is the device 11B.

The management server 10 also transmits a DeviceControl object for performing processing as corresponding to the device 11 to the DS 13 in response to a request from the DS 13. The DeviceControl object includes the device ID and public key information of the DPC 14, the source (sub) of the access token is the DS 13, and the destination (aud) is the DPC 14.

The DPC 14 communicates with the device 11A by using the access point information related to the device 11A shared with the App apparatus 12A, and transmits a SceneMode object to the device 11A to specify data destination information and the like. The DPC 14 also communicates with the device 11B by using the access point information related to the device 11B shared with the App apparatus 12A, and transmits a SceneMode object to the device 11B to specify data destination information and the like. Furthermore, the DPC 14 communicates with the DS 13 by using the access point information related to the DS 13 shared with the App apparatus 12A, and transmits a SceneMode object to the DS 13 to specify data destination information and the like.

As described above, the NICE Version 1.1 is similar to the NICE Version 1.0.1 in that an AppControl object or a DeviceControl object is transmitted from the management server 10 to the devices 11A and 11B, the App apparatus 12A, and the DS 13, but differs from the NICE Version 1.0.1 in that a SceneMode object is transmitted from the DPC 14. In addition, the NICE Version 1.1 defines an access token for the application layer and supports only WebAPI.

### NICE Basic Operation Sequence

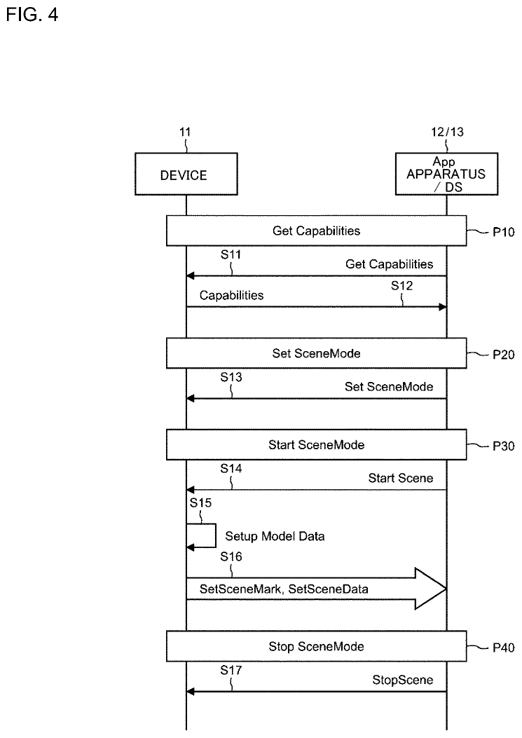

Next, referring to FIG. 4, a basic operation sequence performed between two entities in the NICE Version 1.0.1 standard will be described.

FIG. 4 is a sequence diagram illustrating an example of the basic operation sequence in the NICE Version 1.0.1 standard. In FIG. 4, the App apparatus 12 or the DS 13, which is a higher-level entity that issues an instruction to the device 11, is collectively referred to as the App apparatus 12/DS 13.

As illustrated in FIG. 4, the basic operation is made up of: a capability acquisition phase P10 in which the App apparatus 12/DS 13 acquires the processing capability of the device 11, a mode setting phase P20 in which a SceneMode object is set in the device 11, an execution phase P30 in which the device 11 executes predetermined data processing (e.g., detection processing by AI) specified in the SceneMode object, and an end phase P40 in which the device 11 ends the predetermined data processing. In the SceneMode object, a scene mode can be specified such as human detection or moving object detection, for example. Examples of the scene mode include, for example, “1. Face, 2. Human, 3. Object Label, 4. Animal, 5. Text/Logo/QRCode, 6. Vehicle, 7. Custom”.

### Capability Acquisition Phase P10

In the capability acquisition phase P10, first, in step S11, the App apparatus 12/DS 13 notifies the device 11 of GetCapabilities, which is an instruction (command) for reporting the processing capability of the device 11 to the App apparatus 12/DS 13. In response to this, in step S12, the device 11 notifies the App apparatus 12/DS 13 of information (Capabilities) related to its own processing capability. The information (Capabilities) related to the processing capability of each device 11 may be managed in advance in the App apparatus 12/DS 13 by performing the capability acquisition phase P10 in advance.

### Mode Setting Phase P20

In the mode setting phase P20, in step S13, the App apparatus 12/DS 13 notifies the device 11 of SetSceneMode, which is an instruction as to which SceneMode object to use.

### Execution Phase P30

In the execution phase P30, in step S14, the App apparatus 12/DS 13 notifies the device 11 of StartScene, which is an instruction to start the predetermined data processing specified by SetSceneMode. When StartScene is notified, then in step S15, the device 11 executes the data processing specified by the SceneMode object in the mode setting phase P20. Then, in step S16, the device 11 generates transmission data based on the acquired data, and transmits the data to the App apparatus 12/DS 13 by using SetSceneMark or SetSceneData. Through SetSceneData, data itself such as images and sound is transmitted. Through SetSceneMark, metadata associated with images, sound, and the like are transmitted. For example, when human detection is set as a SceneMode object, information such as a thumbnail and a timestamp when a person appears is transmitted by using SetSceneMark. The destination of the data transmitted using SetSceneMark and SetSceneData is not limited to the App apparatus 12/DS 13, but may be another device 11 or the like.

### End Phase P40

In the end phase P40, in step S17, the App apparatus 12/DS 13 notifies the device 11 of StopScene, which is an instruction to end the predetermined data processing specified by the SceneMode object. In response to this, the device 11 ends the predetermined data processing specified by the SceneMode object.

In the NICE standard, the data acquired by the device 11 is transmitted to the DS 13 and the App apparatus 12 through the above-described basic operation sequence.

### 2. Desired System Configuration

Next, a desired configuration of the data processing system 1 will be described, assuming the above-described current NICE standard.

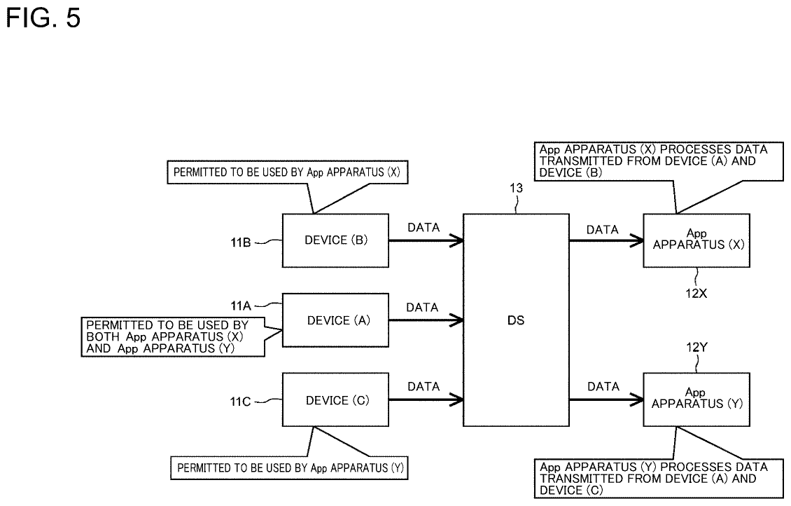

FIG. 5 is a block diagram illustrating the desired configuration example of the data processing system 1.

The data processing system 1 in FIG. 5 is made up of three devices 11: a device 11A, a device 11B, and a device 11C; a DS 13; and two App apparatuses 12: an App apparatus 12X and an App apparatus 12Y.

The App apparatus 12X processes data transmitted from the device 11A and the device 11B. The App apparatus 12Y processes data transmitted from the device 11A and the device 11C.

The device 11A is permitted to be used by both the App apparatus 12X and the App apparatus 12Y. The device 11B is permitted to be used by the App apparatus 12X. The device 11C is permitted to be used by the App apparatus 12Y.

The DS 13 is interposed between the three devices 11A to 11C and the two App apparatuses 12X and 12Y, and as a subcontractor for the App apparatuses 12X and 12Y, is required to appropriately distribute and transmit data transmitted from the three devices 11A, 11B, and 11C to the App apparatuses 12X or 12Y.

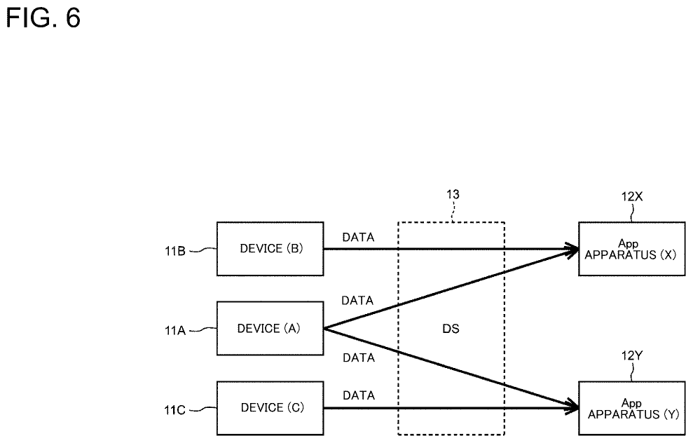

Specifically, as illustrated in FIG. 6, the DS 13 transmits data transmitted from the device 11A to the App apparatuses 12X and 12Y. The DS 13 also transmits data transmitted from the device 11B only to the App apparatus 12X, and transmits data transmitted from the device 11C only to the App apparatus 12Y. Conversely, the DS 13 is required to perform control such that data transmitted from the device 11C is not transmitted to the App apparatus 12X, and data transmitted from the device 11B is not transmitted to the App apparatus 12Y.

The App apparatuses 12X and 12Y would like to use the transmitted data without being overly concerned about which device 11 that is permitted to use the data has transmitted the data. However, if the information required is which device 11 has transmitted the data, it is necessary to be able to accurately identify it.

The DS 13 may perform additional processing on the data depending on the device 11 that has transmitted the data and the App apparatus 12 which is the destination, and then transfer the resulting data, but this is omitted in this processing.

As described above, when the DS 13 is to function not as a subcontractor for one App apparatus 12 but as a subcontractor for two or more App apparatuses 12, there are the following problems in the current NICE Version 1.0.1 standard.

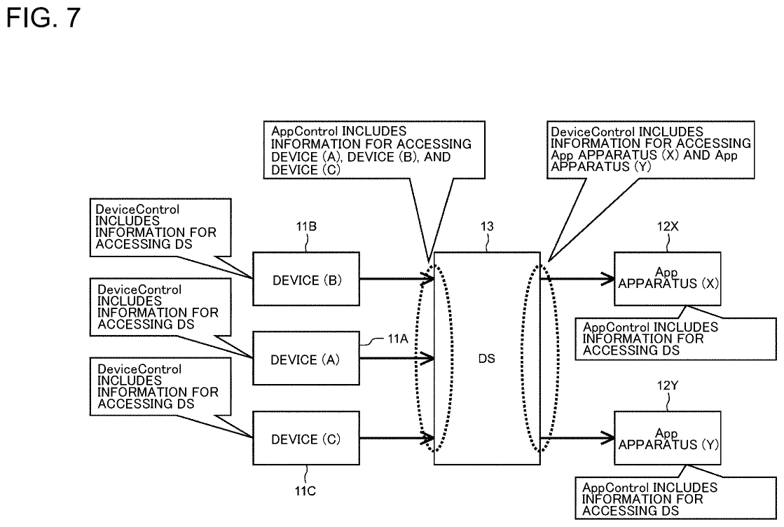

As illustrated in FIG. 7, an AppControl object provided to each App apparatus 12 includes access point information for accessing the DS 13. For example, an access token required for accessing the DS 13 is included in an AppControl object provided to each App apparatus 12.

The DeviceControl object provided to the DS 13 includes access point information for accessing the App apparatuses 12X and 12Y. For example, an access token required for accessing the App apparatus 12X and an access token required for accessing the App apparatus 12Y are included in the DeviceControl object provided to the DS 13.

On the other hand, the AppControl object provided to the DS 13 includes access point information for accessing the devices 11A, 11B, and 11C. For example, three access tokens required for accessing the devices 11A, 11B, and 11C are included in the AppControl object provided to the DS 13.

The DeviceControl object provided to the devices 11A, 11B, and 11C includes access point information for accessing the DS 13. For example, an access token required to access the DS 13 is included in the DeviceControl object provided to the devices 11A, 11B, and 11C.

However, since the DS 13 is not notified of the appropriate association (correspondence) between the App apparatuses 12 and the devices 11, the DS 13 does not know that the data transmitted from the device 11C must not be transmitted to the App apparatus 12X. Similarly, the DS 13 does not know that the data transmitted from the device 11B must not be transmitted to the App apparatus 12Y.

There are similar problems in the current NICE Version 1.1 standard. Specifically, the management server 10 manages the devices 11 and the App apparatuses 12 in association with user accounts, but does not have information in which the devices 11 and the App apparatuses 12 are associated with each other individually. Therefore, when a plurality of devices 11 or a plurality of App apparatuses 12 are associated with one user account, it is not possible to specify a device 11 that is allowed to be used for each App apparatus 12.

As described above, in the data processing system 1 compliant to the current NICE Version 1.0.1 and Version 1.1 standards, the DS 13 cannot properly distribute data as described with reference to FIG. 5 and FIG. 6.

Therefore, a system will be described below in which the NICE Version 1.0.1 (with DS) and Version 1.1 standards are partially extended so that the system can appropriately distribute and transmit data when the DS 13 functions as a subcontractor for two or more App apparatuses 12.

### 3. Data Processing System According to First Embodiment

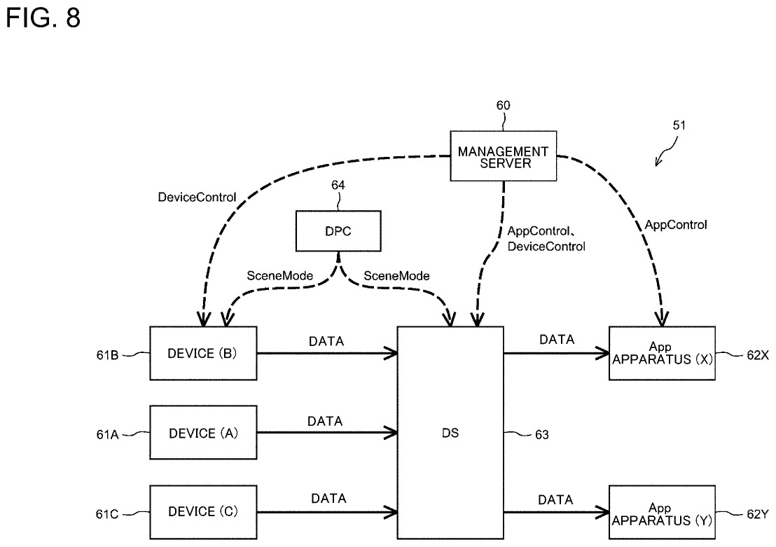

FIG. 8 is a block diagram illustrating a configuration example of a data processing system according to a first embodiment of the present disclosure.

The data processing system 51 illustrated in FIG. 8 includes a management server 60, three devices 61: devices 61A to 61C; two App apparatuses 62: App apparatuses 62X and 62Y; a DS 63; and a DPC 64. Each of the management server 60, the devices 61, the App apparatuses 62, the DS 63, and the DPC 64 constitutes an entity of the data processing system 51.

The management server 60, the devices 61, the App apparatuses 62, the DS 63, and the DPC 64 of the data processing system 51 correspond to the management server 10, the devices 11, the App apparatuses 12, the DS 13, and the DPC 14 of the data processing system 1 described above, respectively, and have the same configuration and function except for the points described below. In other words, each entity of the data processing system 51 operates in accordance with the current NICE Version 1.0.1 (with DS) and Version 1.1 standards, except for the point that the entity has a function to solve the problems described with reference to FIG. 5 to FIG. 8.

The management server 60 manages the devices 61 and the App apparatuses 62 in association with user accounts. The management server 60 has a function of transmitting an AppControl object to each App apparatus 62, a function of transmitting an AppControl object and a DeviceControl object to the DS 63, and a function of transmitting a DeviceControl object to each device 61.

The same point is also that in the NICE Version 1.0.1, a SceneMode object as operation instruction information is provided by a higher-level entity, whereas in the NICE Version 1.1, a SceneMode object is provided by the DPC 64. However, if the data processing system 51 operates in accordance with the NICE Version 1.0.1, DPC 64 can be omitted.

By selectively executing either a first access control method or a second access control method, which will be described below, the data processing system 51 can appropriately distribute data from the devices 61 to at least one of the App apparatuses 62X and 62Y, thereby solving the problems described with reference to FIG. 5 to FIG. 8.

### 4. First Access Control Method (for NICE Version 1.0.1)

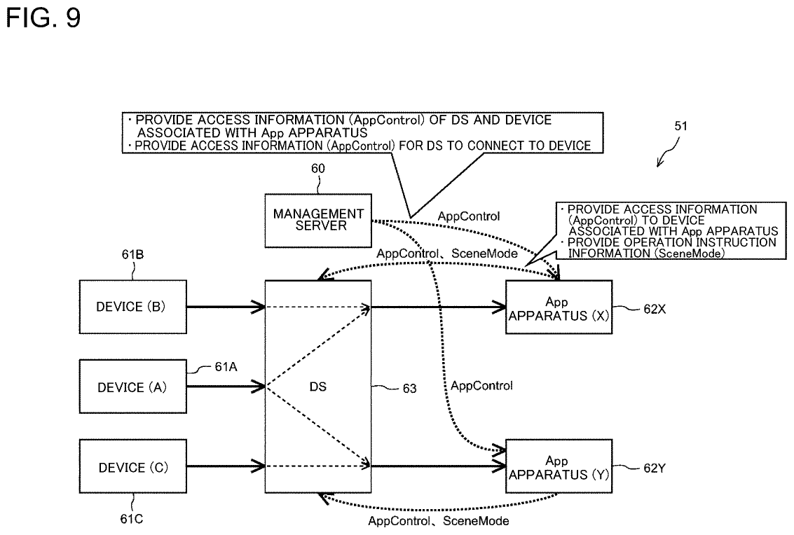

Referring to FIG. 9, an overview of the first access control method executed by the data processing system 51 for the NICE Version 1.0.1 will be described. FIG. 9 describes changes from the existing NICE Version 1.0.1.

In response to a request from an App apparatus 62, the management server 60 transmits to the App apparatus 62 access information (AppControl object) of a device 61 associated with the App apparatus 62 and the App apparatus 62. In response to a request from an App apparatus 62, the management server 60 also transmits to the App apparatus 62 access information for connecting the DS 63 to a device 61 associated with the App apparatus 62. This access information corresponds to, for example, an AppControl object in the NICE Version 1.0.1, and can be used by modifying the existing AppControl object.

The App apparatus 62 transmits to the DS 63 access information (AppControl object) acquired from the management server 60 for the DS 63 to connect to the device 61 associated with the App apparatus 62 itself. Among the devices 61 associated with the App apparatus 62, the access information of an unused device 61, such as a suspended device 61, may be omitted. This access information corresponds to, for example, an AppControl object in the NICE Version 1.0.1, and can be used by modifying the existing AppControl object.

The App apparatus 62 also transmits a SceneMode object, which is operation instruction information, to the DS 63 to instruct the operation. This processing is the same as that of the NICE Version 1.0.1 described above.

In this way, the first access control method employs a method in which an App apparatus 62 acquires access information of a device 61 associated with the App apparatus 62 and the App apparatus 62 from the management server 60, and transmits access information for the DS 63 to connect to the device 61 associated with the App apparatus 62 from the App apparatus 62 to the DS 63. This enables the DS 63 to recognize that the device 61 to which access information has been provided from the App apparatus 62 is the device 61 associated with that App apparatus 62, and to recognize the correspondence between the App apparatus 62 and the device 61.

### First Access Control Flow for NICE Version 1.0.1

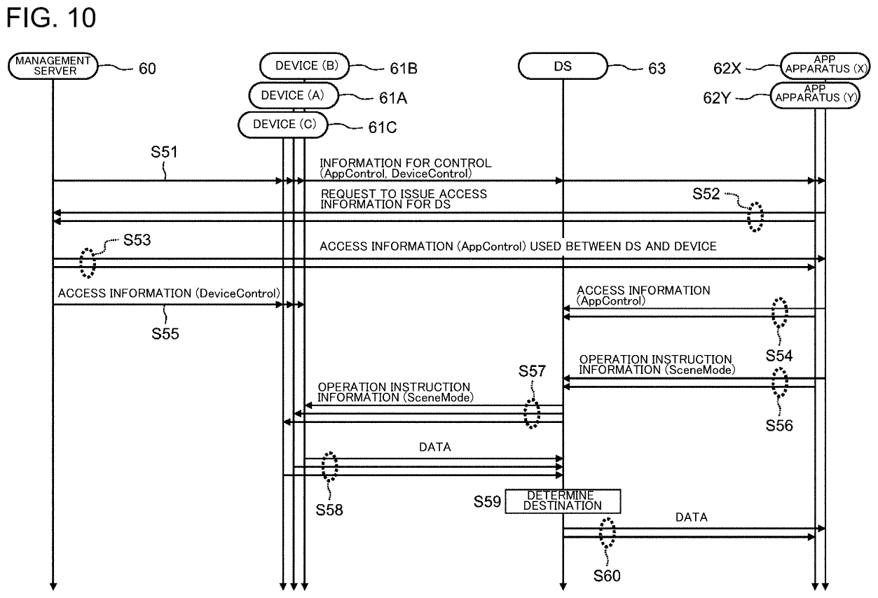

Referring to a flowchart of FIG. 10, first access control processing by the data processing system 51 for the NICE Version 1.0.1 will be described.

First, in step S51, the management server 60 transmits information for control to each entity, that is, the devices 61A to 61C, the App apparatuses 62X and 62Y, and the DS 63, in response to a request from the entity. Specifically, as described with reference to FIG. 2, a DeviceControl object is provided to the devices 61A to 61C, and an App Control object is provided to the App apparatuses 62X and 62Y. To the DS 63, an AppControl object and a DeviceControl object are provided. Here, the AppControl object provided to the App apparatuses 62X and 62Y includes not only information for the App apparatus 62 to communicate with the DS 63, but also information for the DS 63 to communicate with the device 61, which is a communication partner as a subcontractor of the App apparatus 62.

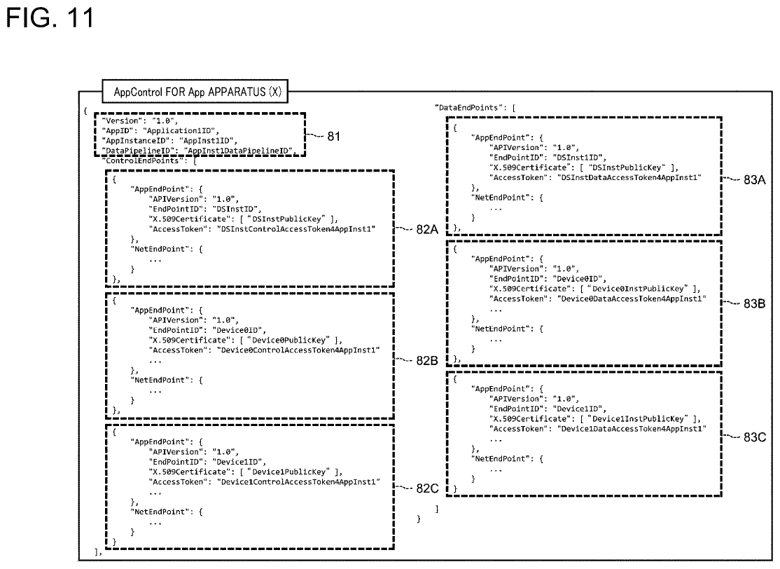

FIG. 11 illustrates an example of an AppControl object supplied as information for control from the management server 60 to the App apparatus 62X in step S51.

The AppControl object supplied from the management server 60 to the App apparatus 62X in step S51 includes apparatus specification information 81, control I/F information 82A to 82C, and data I/F information 83A to 83C.

The apparatus specification information 81 is information for specifying the App apparatus 62X itself or the data pipeline of the App apparatus 62X. For example, the apparatus specification information 81 specifies that: version information “Version” is “1.0”; identification information (apparatus identification information) “AppID” of the App apparatus 62X is “Application1ID”; identification information (instance identification information) of an instance being executed on the App apparatus 62, “AppInstanceID”, is “AppInst1ID”; and identification information (data pipeline identification information) of the data pipeline, “DataPipelineID”, is “AppInst1DataPipelineID”. The data pipeline identification information is information for, when a single App apparatus 62 uses a plurality of data pipelines, identifying each of the data pipelines. When a single App apparatus 62 uses one data pipeline, the data pipeline can be identified by the instance identification information, and therefore the data pipeline identification information may not be used.

“ControlEndPoints” following the apparatus specification information 81:[ . . . ] includes information for the App apparatus 62X to communicate with Control I/F of the communication partner, and in the example of FIG. 11, includes the control I/F information 82A to 82C.

The control I/F information 82A is information for the App apparatus 62X to communicate with Control I/F of the DS 63. The control I/F information 82A includes “APIVersion” which is API version information, “EndPointID” which is information for specifying the communication partner (partner apparatus specification information), “X.509Certificate” which is an X.509 certificate (public key), and “AccessToken” which is an access token. In the control I/F information 82A, “APIVersion” is “1.0”, “EndPointID” is “DSInstID”, “X.509Certificate” is “DSInstPublicKey”, and “AccessToken” is “DSInstControlAccessToken4AppInst1”.

The control I/F information 82B is information for the App apparatus 62X to communicate with Control I/F of the device 61A. In the control I/F information 82B, “APIVersion” is “1.0”, “EndPointID” is “Device0ID”, “X.509Certificate” is “Device0PublicKey”, and “AccessToken” is “Device0ControlAccessToken4AppInst1”. This access token “Device0ControlAccessToken4AppInst1” is an access token for the App apparatus 62X, and therefore cannot be used by the DS 63.

The control I/F information 82C is information for the App apparatus 62X to communicate with Control I/F of the device 61B. In the control I/F information 82C, “APIVersion” is “1.0”, “EndPointID” is “Device1ID”, “X.509Certificate” is “Device1PublicKey”, and “AccessToken” is “Device1ControlAccessToken4AppInst1”. This access token “Device1ControlAccessToken4AppInst1” is an access token for the App apparatus 62X, and therefore cannot be used by the DS 63.

“ControlEndPoints”: “DataEndPoints” following [ . . . ]:[ . . . ] includes information for the App apparatus 62X to communicate with Data I/F of the communication partner, and in the example of FIG. 11, includes the data I/F information 83A to 83C.

The data I/F information 83A is information for the App apparatus 62X to communicate with Data I/F of the DS 63. The data I/F information 83A includes “APIVersion” which is API version information, “EndPointID” which is information for specifying the communication partner (partner apparatus specification information), “X.509Certificate” which is an X.509 certificate (public key), and “AccessToken” which is an access token. In the example of the data I/F information 83A in FIG. 11, “APIVersion” is “1.0”, “EndPointID” is “DSInstID”, “X.509Certificate” is “DSInstPublicKey”, and “AccessToken” is “DSInstDataAccessToken4AppInst1”.

The data I/F information 83B is information for the App apparatus 62X to communicate with Data I/F of the device 61A. In the data I/F information 83B, “APIVersion” is “1.0”, “EndPointID” is “Device0ID”, “X.509Certificate” is “Device0InstPublicKey”, and “AccessToken” is “Device0DataAccessToken4AppInst1”. This access token “Device0DataAccessToken4AppInst1” is an access token for the App apparatus 62X, and therefore cannot be used by the DS 63.

The data I/F information 83C is information for the App apparatus 62X to communicate with Data I/F of the device 61B. In the data I/F information 83C, “APIVersion” is “1.0”, “EndPointID” is “Device1ID”, “X.509Certificate” is “Device1InstPublicKey”, and “AccessToken” is “Device1ControlAccessToken4AppInst1”. This access token “Device1DataAccessToken4AppInst1” is an access token for the App apparatus 62X, and therefore cannot be used by the DS 63.

The AppControl object supplied from the management server 60 to the App apparatus 62X also includes information for connecting to the devices 61A and 61B associated with the App apparatus 62X based on association information between the App apparatuses 62 and the devices 61 managed by the management server 60, as in the example of FIG. 11.

Next, in step S52 of FIG. 10, the App apparatus 62X requests the management server 60 to issue access information to a device 61 whose authority is to be transferred to the DS 63. The App apparatus 62X is associated with the devices 61A and 61B, and requests the DS 63 to communicate with the devices 61A and 61B, and accordingly, requests the management server 60 to issue access information for the DS 63 to the devices 61A and 61B. Similarly, in step S52, the App apparatus 62Y requests the management server 60 to issue access information for the devices 61A and 61C whose authorities are to be transferred to the DS 63.

Since the request to issue access information in step S52 is not specified in the NICE Version 1.0.1, it is necessary to add a new command (access information issue request command), for example, by calling GetAppControl with request information.

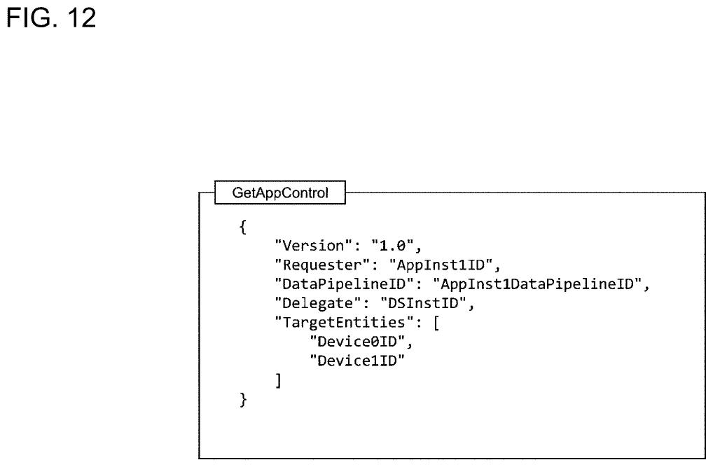

FIG. 12 illustrates an example of the access information issue request command GetAppControl in step S52, in which the App apparatus 62X requests the management server 60 to issue access information for DS.

Examples of the parameters of GetAppControl include, as illustrated in FIG. 12, version information “Version”, requester information “Requester”, data pipeline identification information “DataPipelineID”, authority transfer destination information “Delegate”, and access information request target information “TargetEntities”.

As examples of parameters for the App apparatus 62X to make a request, the version information “Version” is “1.0”, the requester information “Requester” is instance identification information “AppInst1ID” of the App apparatus 62X, the data pipeline identification information “DataPipelineID” is “AppInst1DataPipelineID”, the authority transfer destination information “Delegate” is instance identification information “DSInstID” of the DS 63, and the access information request target information “TargetEntities” is identification information “Device0ID” and “Device1ID” of the devices 61A and 61B. If the data pipeline can be identified without the data pipeline identification information “DataPipelineID”, the data pipeline identification information may not be used.

Next, in step S53 of FIG. 10, the management server 60 refers to the association information managed by the management server 60, and confirms that the DS 63 which is the authority transfer destination and the device 61 which is the access information request target, which are described in the access information issue request command from the App apparatus 62, are associated with the App apparatus 62 which is the requester. Then, the management server 60 transmits access information to be used between the DS 63 and the device 61 to the App apparatus 62 which is the requester. More specifically, access information used by the DS 63 in communicating with the devices 61A and 61B is transmitted from the management server 60 to the App apparatus 62X, and access information used by the DS 63 in communicating with the devices 61A and 61C is transmitted from the management server 60 to the App apparatus 62Y. If the App apparatus 62 requests access information for the DS 63 or the device 61 that is not associated with the App apparatus 62, which is the requester, the request to issue the access information is rejected.

In step S54, in response to a request from the DS 63, the App apparatus 62 transmits to the DS 63 the access information for the DS 63 acquired in response to the access information issue request command. More specifically, the App apparatus 62X transmits to the DS 63 access information that the DS 63 uses in communicating with the devices 61A and 61B, and the App apparatus 62Y transmits to the DS 63 access information that the DS 63 uses in communicating with the devices 61A and 61C.

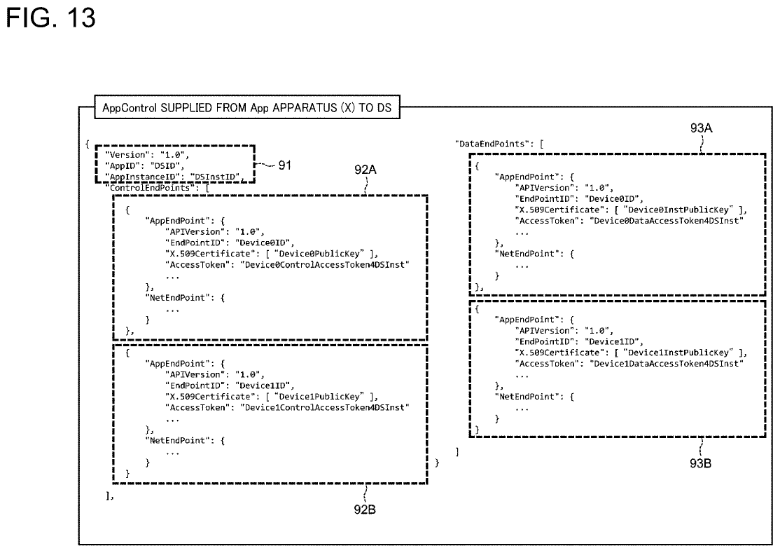

FIG. 13 illustrates an example of access information transmitted from the App apparatus 62X to the DS 63. This access information can be provided, for example, by an AppControl object. This AppControl object has been created by modifying the AppControl object in the NICE Version 1.0.1.

The App apparatus 62X selects the device 61 in accordance with the data pipeline, stores in the AppControl object the access information acquired from the management server 60, and transmits the resulting AppControl object to the DS 63.

The AppControl object provided from the App apparatus 62X to the DS 63 includes apparatus specification information 91, control I/F information 92A and 92B, and data I/F information 93A and 93B.

The apparatus specification information 91 is information for specifying the DS 63 itself or the data pipeline of the DS 63. The apparatus specification information 91 includes, for example, “1.0” as version information “Version”, “DSID” that is identification information of the DS 63 as apparatus identification information “AppID”, and “DSInstID” that is identification information of an instance being executed on the DS 63 as instance identification information “AppInstanceID”. Although omitted in this example, if information for identifying the data pipeline (data pipeline identification information) is necessary, the data pipeline identification information is also included.

“ControlEndPoints” following the apparatus specification information 91:[ . . . ] includes information for the DS 63 to communicate with Control I/F of the communication partner, and in the example of FIG. 13, includes the control I/F information 92A and 92B.

The control I/F information 92A is information for the DS 63 to communicate with Control I/F of the device 61A. The control I/F information 92A includes “APIVersion” which is API version information, “EndPointID” which is information for specifying the communication partner (partner apparatus specification information), “X.509Certificate” which is an X.509 certificate (public key), and “AccessToken” which is an access token. In the control I/F information 92A, “APIVersion” is “1.0”, “EndPointID” is “Device0ID”, “X.509Certificate” is “Device0PublicKey”, and “AccessToken” is “Device0ControlAccessToken4DSInst”.

The control I/F information 92B is information for the DS 63 to communicate with Control I/F of the device 61B. In the control I/F information 92B, “APIVersion” is “1.0”, “EndPointID” is “Device1ID”, “X.509Certificate” is “Device1PublicKey”, and “AccessToken” is “Device1ControlAccessToken4AppInst”.

“ControlEndPoints”: “DataEndPoints” following [ . . . ]:[ . . . ] includes information for the DS 63 to communicate with Data I/F of the communication partner, and in the example of FIG. 13, includes the data I/F information 93A and 93B.

The data I/F information 93A is information for the DS 63 to communicate with Data I/F of the device 61A. The data I/F information 93A includes “APIVersion” which is API version information, “EndPointID” which is information for specifying the communication partner (partner apparatus specification information), “X.509Certificate” which is an X.509 certificate (public key), and “AccessToken” which is an access token. In the example of the data I/F information 93A in FIG. 13, “APIVersion” is “1.0”, “EndPointID” is “Device0ID”, “X.509Certificate” is “Device0InstPublicKey”, and “AccessToken” is “Device0DataAccessToken4DSInst”.

The data I/F information 93B is information for the DS 63 to communicate with Data I/F of the device 61B. In the data I/F information 93B, “APIVersion” is “1.0”, “EndPointID” is “Device1ID”, “X.509Certificate” is “Device1InstPublicKey”, and “AccessToken” is “Device1DataAccessToken4AppInst”.

By acquiring such access information from the App apparatus 62X, the DS 63 can recognize that the App apparatus 62X is associated with the devices 61A and 61B. Thus, this access information corresponds to association information between the device(s) 61 and the App apparatus(es) 62.

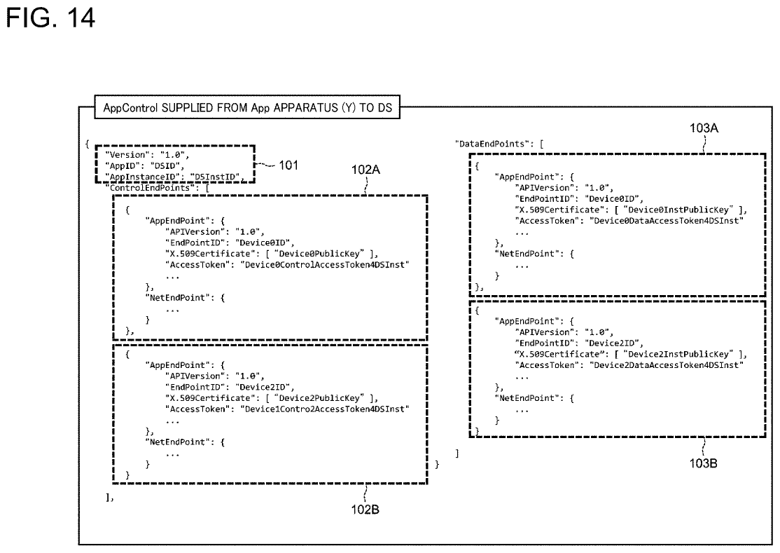

FIG. 14 illustrates an example of access information transmitted from the App apparatus 62Y to the DS 63. This access information can be provided by an AppControl object. This AppControl object has been created by modifying the AppControl object in the NICE Version 1.0.1.

The App apparatus 62Y selects the device 61 in accordance with the data pipeline, stores in the AppControl object the access information acquired from the management server 60, and transmits the resulting AppControl object to the DS 63.

The AppControl object provided from the App apparatus 62Y to the DS 63 includes apparatus specification information 101, control I/F information 102A and 102B, and data I/F information 103A and 103B.

The apparatus specification information 101 is information for specifying the DS 63 itself or the data pipeline of the DS 63. The apparatus specification information 101 includes, for example, “1.0” as version information “Version”, “DSID” that is identification information of the DS 63 as apparatus identification information “AppID”, and “DSInstID” that is identification information of an instance being executed on the DS 63 as instance identification information “AppInstanceID”. Although omitted in this example, if information for identifying the data pipeline (data pipeline identification information) is necessary, the data pipeline identification information is also included.

“ControlEndPoints” following the apparatus specification information 101:[ . . . ] includes information for the DS 63 to communicate with Control I/F of the communication partner, and in the example of FIG. 14, includes the control I/F information 102A and 102B.

The control I/F information 102A is information for the DS 63 to communicate with Control I/F of the device 61A. The control I/F information 102A includes “APIVersion” which is API version information, “EndPointID” which is information for specifying the communication partner (partner apparatus specification information), “X.509Certificate” which is an X.509 certificate (public key), and “AccessToken” which is an access token. In the control I/F information 102A, “APIVersion” is “1.0”, “EndPointID” is “Device0ID”, “X.509Certificate” is “Device0PublicKey”, and “AccessToken” is “Device0ControlAccessToken4DSInst”.

The control I/F information 102B is information for the DS 63 to communicate with Control I/F of the device 61C. In the control I/F information 102B, “APIVersion” is “1.0”, “EndPointID” is “Device2ID”, “X.509Certificate” is “Device2PublicKey”, and “AccessToken” is “Device2ControlAccessToken4AppInst”.

“ControlEndPoints”: “DataEndPoints” following [ . . . ]:[ . . . ] includes information for the DS 63 to communicate with Data I/F of the communication partner, and in the example of FIG. 14, includes the data I/F information 103A and 103B.

The data I/F information 103A is information for the DS 63 to communicate with Data I/F of the device 61A. The data I/F information 93A includes “APIVersion” which is API version information, “EndPointID” which is information for specifying the communication partner (partner apparatus specification information), “X.509Certificate” which is an X.509 certificate (public key), and “AccessToken” which is an access token. In the data I/F information 103A, “APIVersion” is “1.0”, “EndPointID” is “Device0ID”, “X.509Certificate” is “Device0InstPublicKey”, and “AccessToken” is “Device0DataAccessToken4DSInst”.

The data I/F information 103B is information for the DS 63 to communicate with Data I/F of the device 61C. In the data I/F information 103B, “APIVersion” is “1.0”, “EndPointID” is “Device2ID”, “X.509Certificate” is “Device2InstPublicKey”, and “AccessToken” is “Device2DataAccessToken4DSInst”.

By acquiring such access information from the App apparatus 62Y, the DS 63 can recognize that the App apparatus 62Y is associated with the devices 61A and 61C.

The provision of the access information in step S54 described above is performed, for example, by the DS 63 calling GetAppControl for each of the App apparatuses 62 listed in the DeviceControl object provided from the management server 60 in step S51. In this case, the DS 63 requires information for communicating with Management I/F of each App apparatus 62, and therefore, the DeviceControl object supplied to the DS 63 from the management server 60 needs to include information for communicating with Management I/F of each App apparatus 62.

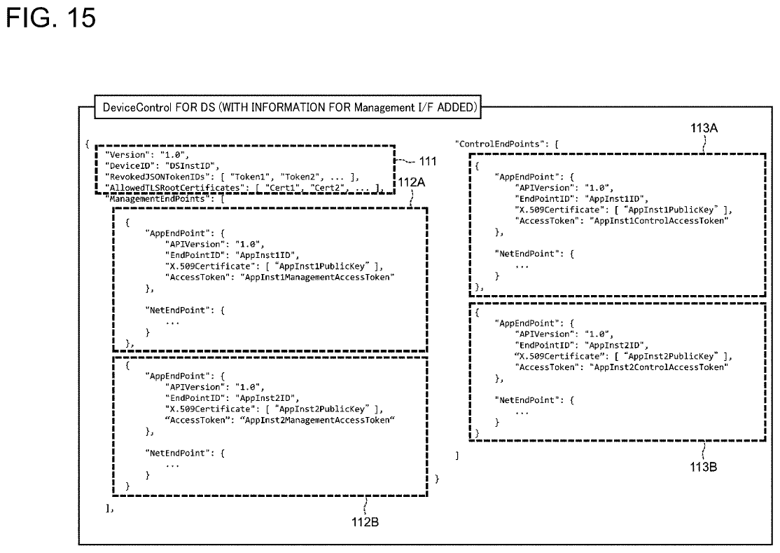

FIG. 15 illustrates an example of a DeviceControl object provided from the management server 60 to the DS 63, which includes information for communicating with Management I/F of each App apparatus 62.

The DeviceControl object supplied from the management server 60 to the DS 63 includes apparatus specification information 111, management I/F information 112A and 112B, and control I/F information 113A and 113B.

The apparatus specification information 111 is information for specifying the DS 63 itself. The apparatus specification information 111 includes, for example, “1.0” as version information “Version”, “DSInstID” that is identification information of the DS 63 as apparatus identification information “DeviceID”, “Token1”, “Token2”, . . . as information (revoked token information) “RevokedJSONTokenIDs” of an access token revoked for establishing a communication path using TLS, and “Cert1”, “Cert2”, . . . as information (TLS root certificate information) “AllowedTLSRootCertificates” of a TLS root certificate for establishing a communication path using TLS.

“ManagementEndPoints” following the apparatus specification information 111:[ . . . ] includes information for the DS 63 to communicate with Management I/F of the communication partner, and in the example of FIG. 15, includes the management I/F information 112A and 112B.

The management I/F information 112A is information for the DS 63 to communicate with Management I/F of the App apparatus 62X. The management I/F information 112A includes “APIVersion” which is API version information, “EndPointID” which is information for specifying the communication partner (partner apparatus specification information), “X.509Certificate” which is an X.509 certificate (public key), and “AccessToken” which is an access token. In the management I/F information 112A, “APIVersion” is “1.0”, “EndPointID” is “AppInst1ID”, “X.509Certificate” is “AppInst1PublicKey”, and “AccessToken” is “AppInst1ManagementAccessToken”.

The management I/F information 112B is information for the DS 63 to communicate with Management I/F of the App apparatus 62Y. In the management I/F information 112B, “APIVersion” is “1.0”, “EndPointID” is “AppInst2ID”, “X.509Certificate” is “AppInst2PublicKey”, and “AccessToken” is “AppInst2ManagementAccessToken”.

“ManagementEndPoints”: “ControlEndPoints” following [ . . . ]:[ . . . ] includes information for the DS 63 to communicate with Control I/F of the communication partner, and in the example of FIG. 15, includes the control I/F information 113A and 113B.

The control I/F information 113A is information for the DS 63 to communicate with Control I/F of the App apparatus 62X. The control I/F information 113A includes “APIVersion” which is API version information, “EndPointID” which is information for specifying the communication partner (partner apparatus specification information), “X.509Certificate” which is an X.509 certificate (public key), and “AccessToken” which is an access token. In the example of the control I/F information 113A, “APIVersion” is “1.0”, “EndPointID” is “AppInst1ID”, “X.509Certificate” is “AppInst1PublicKey”, and “AccessToken” is “AppInst1ControlAccessToken”.

The control I/F information 113B is information for the DS 63 to communicate with Control I/F of the App apparatus 62Y. In the control I/F information 113B, “APIVersion” is “1.0”, “EndPointID” is “AppInst2ID”, “X.509Certificate” is “AppInst2PublicKey”, and “AccessToken” is “AppInst2ControlAccessToken”.

The DeviceControl object illustrated in FIG. 15 is configured by adding information for communicating with Management I/F of each App apparatus 62 to the DeviceControl object defined in the NICE Version 1.0.1. However, the information for communicating with Management I/F and the information for communicating with Control I/F can be common, and therefore, it is also possible to describe them in a shared manner.

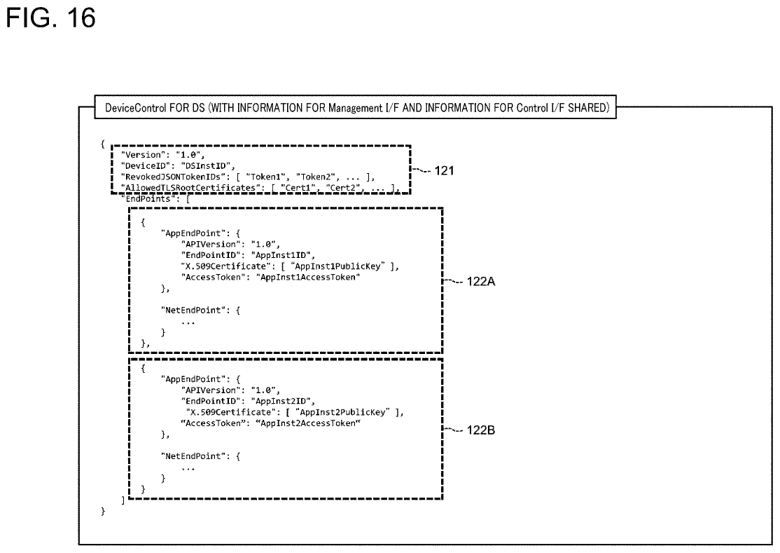

FIG. 16 illustrates an example of a DeviceControl object in the case where information for communicating with Management I/F and information for communicating with Control I/F are shared for use.

The DeviceControl object provided from the management server 60 to the DS 63 includes apparatus specification information 121 and management and control common I/F information 122A and 122B.

The apparatus specification information 121 is similar to the apparatus specification information 111 in FIG. 15, and therefore, the description thereof will be omitted.

“EndPoints” following the apparatus specification information 121:[ . . . ] includes information that is commonly used for the DS 63 to communicate with Management I/F and Control I/F of the communication partner, and in the example of FIG. 15, includes the management and control common I/F information 122A and 122B.

The management and control common I/F information 122A is information for the DS 63 to communicate with Management I/F and Control I/F of the App apparatus 62X. The management and control common I/F information 122B is information for the DS 63 to communicate with Management I/F and Control I/F of the App apparatus 62Y. Each item is the same as that in FIG. 14, and therefore, the description thereof will be omitted.

Next, in step S55 of FIG. 10, the management server 60 transmits a DeviceControl object to each device 61, thereby transmitting to each device 11 access information for each device 61 to communicate with the DS 63. In the NICE Version 1.0.1, the DeviceControl object can be transmitted in response to a request from each device 61, or can be transmitted without a request.

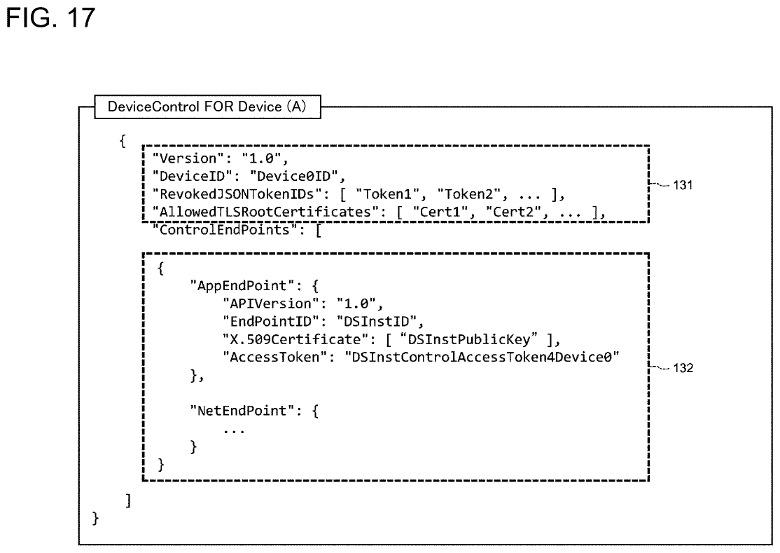

FIG. 17 illustrates an example of a DeviceControl object provided from the management server 60 to the device 61A.

The DeviceControl object provided from the management server 60 to the device 61A includes apparatus specification information 131 and control I/F information 132.

The apparatus specification information 131 is information for specifying the device 61A itself. The apparatus specification information 131 includes, for example, “1.0” as version information “Version”, “DeviceOID” that is identification information of the device 61A as apparatus identification information “DeviceID”, “Token1”, “Token2”, . . . as information (revoked token information) “RevokedJSONTokenIDs” of an access token revoked for establishing a communication path using TLS, and “Cert1”, “Cert2”, . . . as information (TLS root certificate information) “AllowedTLSRootCertificates” of a TLS root certificate for establishing a communication path using TLS.

“ControlEndPoints” following the apparatus specification information 131:[ . . . ] includes information for the device 61A to communicate with Control I/F of the communication partner, and in the example of FIG. 17, includes the control I/F information 132.

The control I/F information 132 is information for the device 61A to communicate with Control I/F of the DS 63. The control I/F information 132 includes “APIVersion” which is API version information, “EndPointID” which is information for specifying the communication partner (partner apparatus specification information), “X.509Certificate” which is an X.509 certificate (public key), and “AccessToken” which is an access token. In the control I/F information 132, “APIVersion” is “1.0”, “EndPointID” is “DSInstID”, “X.509Certificate” is “DSInstPublicKey”, and “AccessToken” is “DSInstControlAccessToken4Device0”.

The processing of steps S54 and S55 executed after step S53 may be executed either first or simultaneously.

After step S54, then in step S56, each App apparatus 62 transmits a SceneMode object for setting a scene mode as operation instruction information to the DS 63 to instruct the operation. For example, the DS 63 calls GetAppControl for each of the App apparatuses 62 listed in the DeviceControl object acquired in step S51, and accordingly, each App apparatus 62 transmits a SceneMode object as operation instruction information to the DS 63. By acquiring the SceneMode object, the DS 63 can recognize the correspondence of device 61—App apparatus 62—SceneMode.

In step S57, the DS 63 transmits to each device 61 a SceneMode object for setting a scene mode as operation instruction information based on the access information and the operation instruction information, which are supplied from each App apparatus 62, to instruct the operation. More specifically, the device 61A is instructed to operate in accordance with the correspondence of device 61A—App apparatus 62X—SceneMode, and the correspondence of device 61A—App apparatus 62Y—SceneMode. The device 61B is instructed to operate in accordance with the correspondence of device 61B—App apparatus 62X—SceneMode, and the device 61C is instructed to operate in accordance with the correspondence of device 61C—App apparatus 62Y—SceneMode.

In step S58, each device 61 executes an operation based on the SceneMode object, such as human detection or moving object detection, and transmits data as the detection result by using SetSceneData or SetSceneMark.

In step S59, the DS 63 acquires the data transmitted from each device 61 and determines the App apparatus 62 to which the data is to be transmitted, and in step S60 transmits the data to the determined App apparatus 62 by using SetSceneData or SetSceneMark.

In step S59, the DS 63 may transmit data from the device 61B to the App apparatus 62X, and transmit data from the device 61C to the App apparatus 62X, but needs to determine whether the data from the device 61A is to be transmitted to the App apparatus 62X or to the App apparatus 62Y. For this reason, SetSceneData and SetSceneMark, which are objects for transmitting data, are configured to include operation instruction identification information that indicates which operation instruction (SceneMode object) the data has been detected based on.

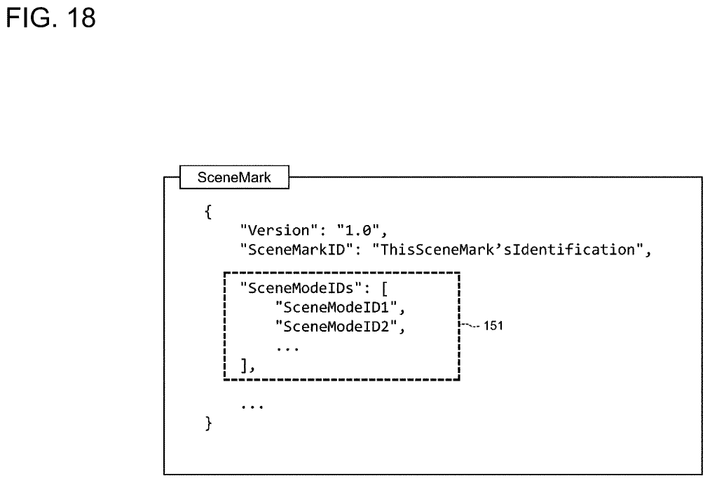

FIG. 18 illustrates a configuration example of a case where a SceneMark object of SetSceneMark includes operation instruction identification information.

For example, as illustrated in FIG. 18, the SceneMark object includes “SceneModeIDs” which is operation instruction identification information 151 for identifying the operation instruction (SceneMode object) that is the source of generating the data. “SceneModeID1” and “SceneModeID2” are scene mode identification information for identifying the SceneMode object.

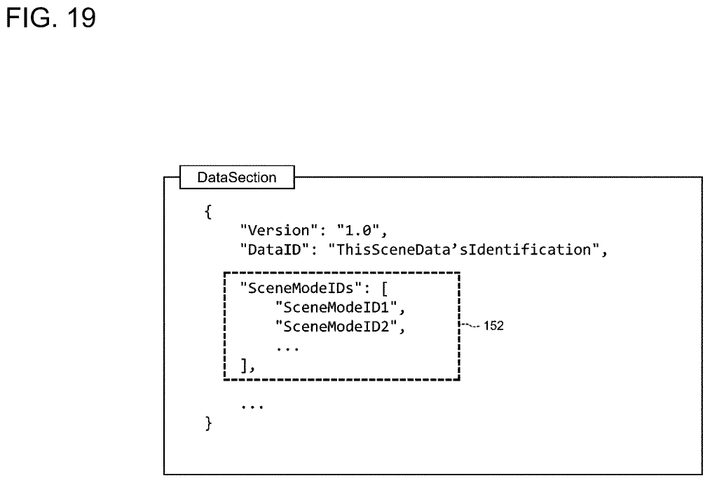

FIG. 19 illustrates a configuration example of a case where a DataSection object of SetSceneData includes operation instruction identification information.

For example, as illustrated in FIG. 19, the DataSection object includes “SceneModeIDs” which is operation instruction identification information 152 for identifying the operation instruction (SceneMode object) that is the source of generating the data.

In the examples of FIG. 18 and FIG. 19, “SceneModeIDs”, which is the operation instruction identification information 152, is expressed in an array format such as [“SceneModeID1”, “SceneModeID2”, . . . ], to allow a plurality of operation instructions to be listed. If only one operation instruction needs to be specified, a single format may be used instead of an array format.

Not only the SceneData object and the SceneMark object, but also their related objects such as a SceneDataManifest object and a SceneMarkManifest object can include operation instruction identification information. SceneDataManifest is an object of data that includes a reference and URI to a file including SceneData, and SceneMarkManifest is an object of data that includes a reference and URI to SceneMark. The DS 63 determines a destination of the data based on the operation instruction identification information included in the SceneData object or the SceneMark object as the operation instruction information, and transmits the data to the App apparatus 62 determined as the destination.

The first access control method by the data processing system 51 for the NICE Version 1.0.1 is performed as described above.

### 5. First Access Control Method (for NICE Version 1.1)

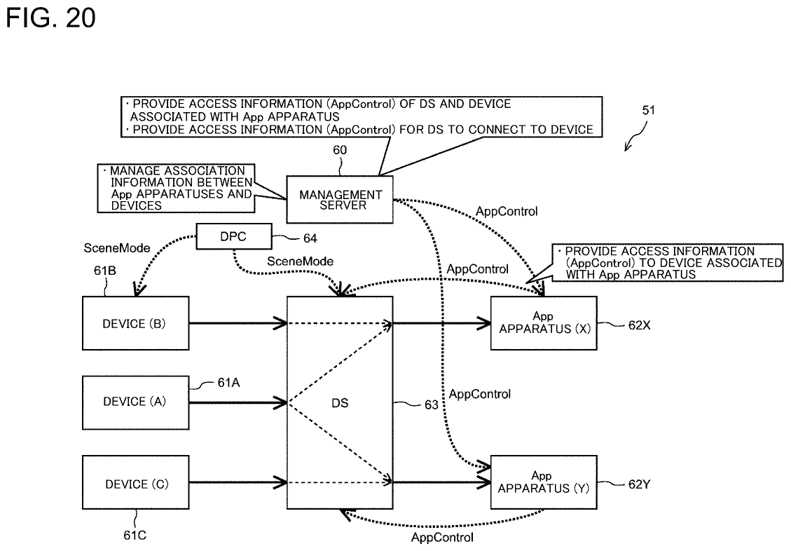

Next, referring to FIG. 20, the first access control method for the NICE Version 1.1 will be described. FIG. 20 describes changes from the existing NICE Version 1.1.

In the NICE Version 1.1, a data pipeline controller (DPC) 64 is newly added to the data processing system 51.

In the existing NICE Version 1.1, the management server 10 manages the devices 11 and the App apparatuses 12 in association with user accounts, but does not have information in which the devices 11 and the App apparatuses 12 are associated with each other directly. Therefore, the management server 60, which executes the first access control method, manages the devices 61 and the App apparatuses 62 in association with user accounts, and also manages the devices 61 and the App apparatuses 62 in association with each other. In other words, the management server 60 manages the correspondence between the devices 61 and the App apparatuses 62 in the same manner as the NICE Version 1.0.1.

In response to a request from an App apparatus 62, the management server 60 transmits to the App apparatus 62 access information (AppControl object) of a device 61 associated with the App apparatus 62 and the App apparatus 62. In response to a request from an App apparatus 62, the management server 60 also transmits to the App apparatus 62 access information for connecting the DS 63 to a device 61 associated with the App apparatus 62. The provision of the access information from the management server 60 to the App apparatus 62 is the same as in the NICE Version 1.0.1 described above.

The App apparatus 62 transmits to the DS 63 access information (AppControl object) acquired from the management server 60 to connect to the device 61 associated with the App apparatus 62 itself. Among the devices 61 associated with the App apparatus 62, the access information of an unused device 61, such as a suspended device 61, may be omitted. The provision of the access information from this App apparatus 62 to the device 61 is the same as in the NICE Version 1.0.1 described above.

On the other hand, in the NICE Version 1.0.1 described above, a SceneMode object, which is operation instruction information, is transmitted from the App apparatus 62 to the DS 63, but in the NICE Version 1.1, it is transmitted from the DPC 64 to each device 61 and the DS 63. In other words, in response to a request from the device 61 or the DS 63, the DPC 64 transmits a SceneMode object, which is operation instruction information, to the device 61 or the DS 63. At this time, for each App apparatus 62, the DPC 64 transmits the SceneMode object to the DS 63.

### First Access Control Flow for NICE Version 1.1

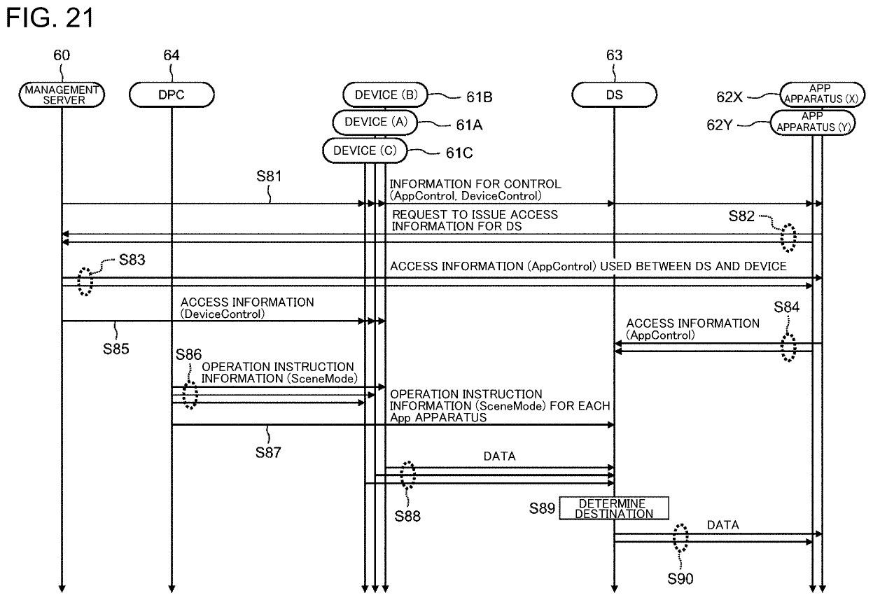

Referring to a flowchart of FIG. 21, the first access control processing by the data processing system 51 for the NICE Version 1.1 will be described.

First, in step S81, the management server 60 transmits information for control to each entity, that is, the devices 61A to 61C, the App apparatuses 62X and 62Y, and the DS 63, in response to a request from the entity. Specifically, as described with reference to FIG. 2, a DeviceControl object is provided to the devices 61A to 61C, and an AppControl object is provided to the App apparatuses 62X and 62Y. To the DS 63, an AppControl object and a DeviceControl object are provided. Here, the AppControl object provided to the App apparatuses 62X and 62Y includes not only information for the App apparatus 62 to communicate with the DS 63, but also information for the DS 63 to communicate with the device 61, which is a communication partner as a subcontractor of the App apparatus 62.

In step S81, as the AppControl object supplied as information for control from the management server 60 to the App apparatus 62X, the example of the AppControl object illustrated in FIG. 11 can be applied. As the DeviceControl object supplied to the DS 63 from the management server 60, the example of the DeviceControl object in FIG. 15 or FIG. 16 including information for communicating with Management I/F of each App apparatus 62 can be applied.

In step S82, the App apparatus 62X requests the management server 60 to issue access information to a device 61 whose authority is to be transferred to the DS 63. The App apparatus 62X is associated with the devices 61A and 61B, and requests the DS 63 to communicate with the devices 61A and 61B, and accordingly, requests the management server 60 to issue access information for the DS 63 to the devices 61A and 61B. Similarly, in step S52, the App apparatus 62Y requests the management server 60 to issue access information for the devices 61A and 61C whose authorities are to be transferred to the DS 63. To the access information issue request in step S82, the example of GetAppControl in FIG. 12 described in the first access control processing for the NICE Version 1.0.1 can be applied.

In step S83, the management server 60 refers to the association information managed by the management server 60, and confirms that the DS 63 which is the authority transfer destination and the device 61 which is the access information request target, which are described in the access information issue request command from the App apparatus 62, are associated with the App apparatus 62 which is the requester. Then, the management server 60 transmits access information to be used between the DS 63 and the device 61 to the App apparatus 62 which is the requester.

In step S84, in response to a request from the DS 63, the App apparatus 62 transmits to the DS 63 the access information for the DS 63 acquired in response to the access information issue request command. As an example of the access information transmitted from the App apparatus 62X to the DS 63, the example of the AppControl object in FIG. 13 described in the first access control processing for the NICE Version 1.0.1 can be applied. As an example of the access information transmitted from the App apparatus 62Y to the DS 63, the example of the AppControl object in FIG. 14 can be applied.

Next, in step S85, the management server 60 transmits a DeviceControl object in response to a request from each device 61, thereby transmitting to each device 11 access information for each device 61 to communicate with the DS 63. As an example of the DeviceControl object supplied from the management server 60 to the device 61A, the example of the DeviceControl object in FIG. 17 described in the first access control processing for the NICE Version 1.0.1 can be applied.

The processing of steps S84 and S85 executed after step S83 may be executed either first or simultaneously.

After step S85, then in step S86, each device 61 makes a request for a SceneMode object as operation instruction information to the DPC 64, and acquires the SceneMode object from the DPC 64. The DPC 64 instructs the operation by transmitting a SceneMode object in response to a request from each device 61.

Subsequently, in step S87, the DS 63 makes a request for a SceneMode object as operation instruction information to the DPC 64, and acquires the SceneMode object from the DPC 64. The DPC 64 instructs the operation by transmitting a SceneMode object in response to a request from the DS 63. At this time, the DS 63 needs to acquire the SceneMode object for each App apparatus 62. For example, the DS 63 calls GetSceneMode by specifying the App apparatuses 62 listed in the DeviceControl object acquired in step S81, and accordingly, the DPC 64 transmits a SceneMode object for the specified App apparatus 62 to the DS 63.

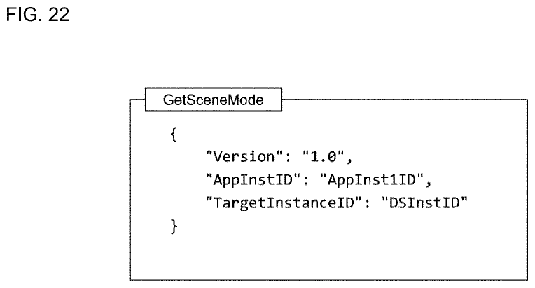

FIG. 22 illustrates an example of a command GetSceneMode for acquiring a SceneMode object for each App apparatus 62, and illustrates an example of GetSceneMode to make a request for operation instruction information for the App apparatus 62X to the DPC 64.

Examples of the parameters of GetSceneMode include, as illustrated in FIG. 22, version information “Version”, App apparatus identification information “AppInstID”, and operation instruction target information “TargetInstanceID”. In the examples of FIG. 22, App apparatus identification information “AppInstID” is instance identification information “AppInst1ID” of the App apparatus 62X, and operation instruction target information “TargetInstanceID” is instance identification information “DSInstID” of the DS 63, which are examples of making a request for operation instruction information for the App apparatus 62X to the DS 63. Although omitted in the examples, if information for identifying data pipeline (data pipeline identification information) is necessary, the data pipeline identification information is also included.

The DS 63 can acquire the control information for control from the management server 60 in step S81, the access information from each App apparatus 62 in step S84, and the operation instruction information in step S87, thereby recognizing the correspondence of device 61—App apparatus 62—SceneMode.

In step S88, each device 61 executes an operation based on the SceneMode object, such as human detection or moving object detection, and transmits data as the detection result by using SetSceneData or SetSceneMark.

In step S89, the DS 63 acquires the data transmitted from each device 61 and determines the App apparatus 62 to which the data is to be transmitted, and in step S90 transmits the data to the determined App apparatus 62 by using SetSceneData or SetSceneMark. As with the NICE Version 1.0.1 described above, the data object includes operation instruction identification information indicating which operation instruction (SceneMode object) the data has been detected based on, as in SceneMark in FIG. 18 and DataSection in FIG. 19.

The first access control method by the data processing system 51 for the NICE Version 1.1 is performed as described above.

As described above, the first access control method employs a method in which an App apparatus 62 acquires access information of a device 61 associated with the App apparatus 62 and the App apparatus 62 from the management server 60, and transmits access information for the DS 63 to connect to the device 61 associated with the App apparatus 62 from the App apparatus 62 to the DS 63. This enables the DS 63 to recognize that the device 61 to which access information has been provided from the App apparatus 62 is the device 61 associated with that App apparatus 62, and to recognize the correspondence between the App apparatus 62 and the device 61.

### 6. Second Access Control Method (for NICE Version 1.0.1)

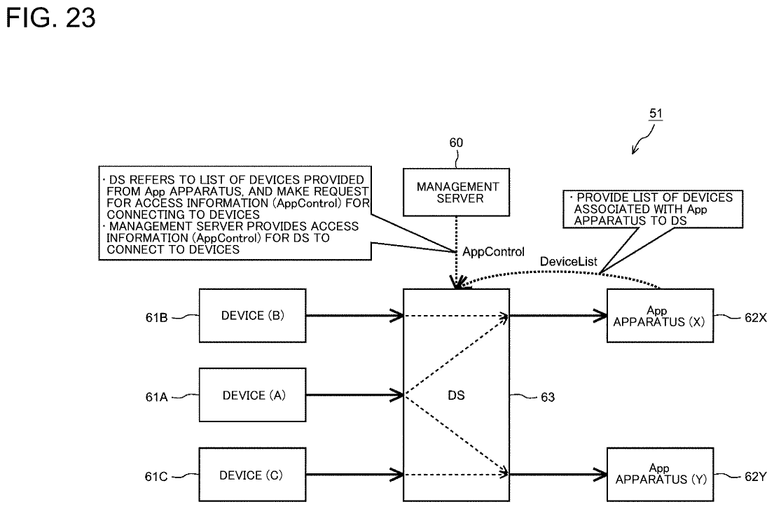

Next, referring to FIG. 23, an overview of the second access control method executed by the data processing system 51 for the NICE Version 1.0.1 will be described. In FIG. 23, differences from the first access control method described above will be described, and changes from the existing NICE Version 1.0.1 will also be described.

In the first access control method described above, the management server 60 provides to each App apparatus 62 not only its own (App apparatus 62) access information, but also access information for the DS 63 to connect to the device 61 associated with that App apparatus 62. In the first access control method, the management server 60 does not need to provide to each DS 63 access information for the DS 63 to connect to the device 61.

In contrast to this, in the second access control method, access information for connecting the DS 63 to the device 61 associated with the App apparatus 62 is not provided from the management server 60 to each App apparatus 62. In other words, in the second access control method, the AppControl object transmitted from the management server 60 to each App apparatus 62 is the same as in the existing NICE Version 1.0.1.

Since the management server 60 does not provide to each App apparatus 62 access information for the device 61 to be used by the DS 63, the processing of transmitting access information from the App apparatus 62 to the DS 63 for connecting the DS 63 to the device 61 associated with the App apparatus 62 is also not executed.

On the other hand, the second access control method differs from the first access control method described above in that each App apparatus 62 provides to the DS 63 a device list (DeviceList object) which is a list of devices 61 associated with the App apparatus 62. This device list is different from the DeviceList object provided from the management server 60 to each App apparatus 62 in the existing NICE Version 1.0.1. The device list provided from the App apparatus 62 to the DS 63 is a device list that lists devices that are to cause the DS 63 to execute processing among the devices 61 associated with itself (the App apparatus 62).

The DS 63 refers to the device list (DeviceList object) provided from each App apparatus 62, and makes a request for access information for connecting to the device 61 to the management server 60. In response to the request from the DS 63, the management server 60 transmits to the DS 63 access information for the DS 63 to connect to the device 61. This access information corresponds to, for example, an AppControl object in the NICE Version 1.0.1, and can be used by modifying the existing AppControl object.

In the first access control method, the DS 63 acquires access information for the DS 63 to connect to the device 61 associated with the App apparatus 62 via the App apparatus 62. In contrast to this, in the second access control method, a method is adopted in which the DS 63 acquires, directly from the management server 60, access information for the DS 63 to connect to the device 61 associated with the App apparatus 62. The DS 63 can acquire a device list (DeviceList object) from the App apparatus 62, thereby recognizing the device(s) 61 associated with the App apparatus 62, that is, recognizing the correspondence between the App apparatus 62 and the device(s) 61, and accordingly, acquires, directly from the management server 60, access information for the DS 63 to connect to the device(s) 61. This access information corresponds to association information between the device(es) 61 and the App apparatus(es) 62.

### Second Access Control Flow for NICE Version 1.0.1

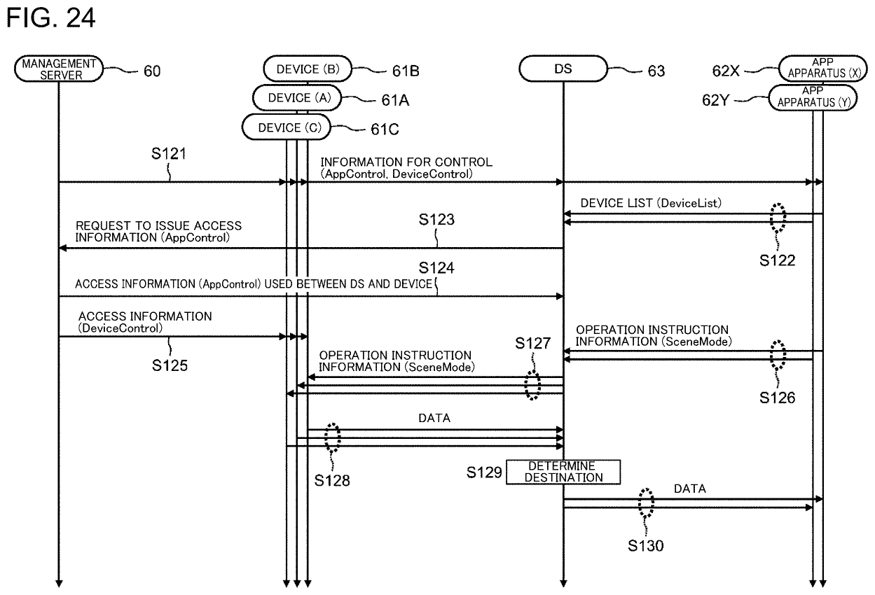

Referring to a flowchart of FIG. 24, second access control processing by the data processing system 51 for the NICE Version 1.0.1 will be described.

First, in step S121, the management server 60 transmits information for control to each entity, that is, the devices 61A to 61C, the App apparatuses 62X and 62Y, and the DS 63, in response to a request from the entity. Specifically, as described with reference to FIG. 2, a DeviceControl object is provided to the devices 61A to 61C, and an AppControl object is provided to the App apparatuses 62X and 62Y. To the DS 63, an AppControl object and a DeviceControl object are provided. Here, the AppControl object provided to the App apparatuses 62X and 62Y includes not only information for the App apparatus 62 to communicate with the DS 63, but also information for the DS 63 to communicate with the device 61, which is a communication partner as a subcontractor of the App apparatus 62.

In step S121, as the AppControl object supplied as information for control from the management server 60 to the App apparatus 62X, the example of the AppControl object illustrated in FIG. 11 can be applied. As the DeviceControl object supplied to the DS 63 from the management server 60, the example of the DeviceControl object in FIG. 15 or FIG. 16 including information for communicating with Management I/F of each App apparatus 62 can be applied.

In step S122, the App apparatus 62X transmits to the DS 63 a device list (DeviceList object), which is a list of devices 61 whose authorities are to be transferred to the DS 63. Similarly, in step S122, the App apparatus 62Y transmits to the DS 63 a device list (DeviceList object) which is a list of devices 61 whose authorities are to be transferred to the DS 63. The device list from the App apparatus 62X lists the devices 61A and 61B, and the device list from the App apparatus 62Y lists the devices 61A and 61C.

For example, when the DS 63 calls GetAppControl for each of the App apparatuses 62 listed in the DeviceControl object acquired in step S121, so that the DS 63 makes a request for a device list to each App apparatus 62, each App apparatus 62 transmits a DeviceList object to the DS 63.

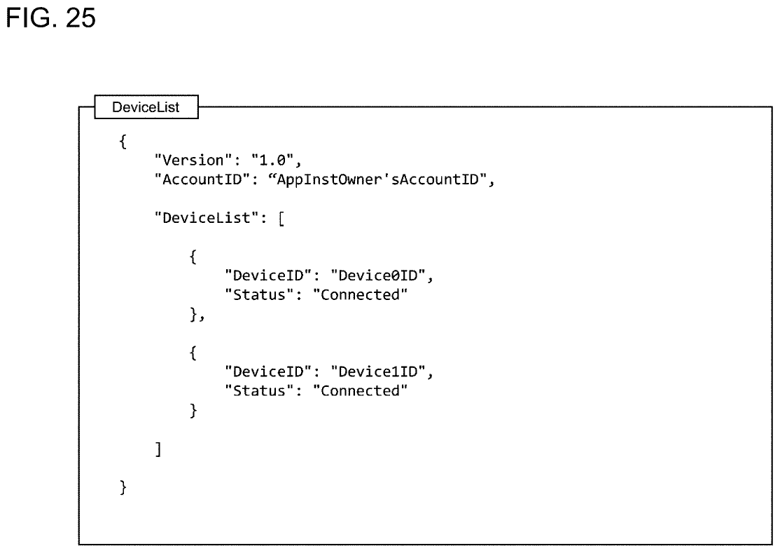

FIG. 25 illustrates an example of a DeviceList object transmitted from the App apparatus 62X to the DS 63.

Examples of the DeviceList object include, as illustrated in FIG. 25, version information “Version”, user account identification information “AccountID”, and device list information “DeviceList”. The device list information “DeviceList” lists apparatus identification information “DeviceID” and information on “Status” indicating the connection status with the device 61, for the devices 61 whose authorities are to be transferred. In the example of FIG. 25, the user account identification information “AccountID” is “AppInstOwner'sAccountID” corresponding to the user account of the App apparatus 62X. The device list information “DeviceList” stores “Device0ID” which is the apparatus identification information “DeviceID” corresponding to the device 61A, and “Connected” which is the connection status “Status”, and “Device1ID” which is the apparatus identification information “DeviceID” corresponding to the device 61B and “Connected” which is the connection status “Status”. Although omitted in this example, if information for identifying data pipeline (data pipeline identification information) is necessary, the data pipeline identification information is also included.

In step S123, the DS 63 requests the management server 60 to issue access information to the device(s) 61, which are listed in the device list and are the authority transfer target(s). To the access information issue request in step S123, a command similar to GetAppControl in FIG. 12 described in the first access control processing for the NICE Version 1.0.1 can be applied.

In step S124, the management server 60 refers to the association information managed by the management server 60, and confirms that the DS 63 which is the authority transfer destination and the device 61 which is the access information request target, which are described in the access information issue request command from the DS 63, are associated with the App apparatus 62 which is the authority transfer source. Then, the management server 60 transmits access information to be used between the DS 63, which is the requester, and the device 61, which is the access destination. To the access information acquired thus, the same example as that of the AppControl object in FIG. 12 and FIG. 13 can be applied.

In step S125, the management server 60 transmits a DeviceControl object to each device 61, thereby transmitting to each device 11 access information for each device 61 to communicate with the DS 63. As an example of the DeviceControl object supplied from the management server 60 to the device 61A, an example similar to that of the DeviceControl object in FIG. 17 described in the first access control processing for the NICE Version 1.0.1 can be applied.

In step S126, each App apparatus 62 transmits a SceneMode object as operation instruction information to the DS 63 to instruct the operation. For example, the DS 63 calls GetAppControl for each of the App apparatuses 62 listed in the DeviceControl object acquired in step S121, and accordingly, each App apparatus 62 transmits a SceneMode object to the DS 63. By acquiring the SceneMode object, the DS 63 can recognize the correspondence of device 61—App apparatus 62—SceneMode.

In step S127, the DS 63 transmits to each device 61 a SceneMode object as operation instruction information based on the access information and the operation instruction information, which are supplied from each App apparatus 62, to instruct the operation. More specifically, the device 61A is instructed to operate in accordance with the correspondence of device 61A—App apparatus 62X—SceneMode, and the correspondence of device 61A—App apparatus 62Y—SceneMode. The device 61B is instructed to operate in accordance with the correspondence of device 61B—App apparatus 62X—SceneMode, and the device 61C is instructed to operate in accordance with the correspondence of device 61C—App apparatus 62Y—SceneMode.

In step S128, each device 61 executes an operation based on the SceneMode object, such as human detection or moving object detection, and transmits data as the detection result by using SetSceneData or SetSceneMark.

In step S129, the DS 63 acquires the data transmitted from each device 61 and determines the App apparatus 62 to which the data is to be transmitted, and in step S130 transmits the data to the determined App apparatus 62 by using SetSceneData or SetSceneMark.

As with the first access control method described above, the object for transmitting the data includes operation instruction identification information indicating which operation instruction (SceneMode object) the data has been detected based on, as in SceneMark in FIG. 18 and the DataSection in FIG. 19.

The second access control method by the data processing system 51 for the NICE Version 1.0.1 is performed as described above.

### 7. Second Access Control Method (for NICE Version 1.1)

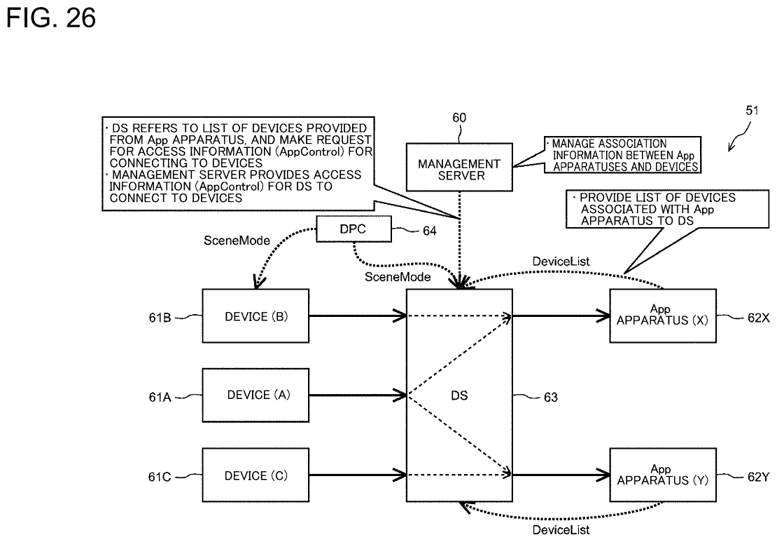

Next, referring to FIG. 26, an overview of the second access control method for the NICE Version 1.1 will be described. FIG. 26 describes changes from the existing NICE Version 1.1.

In the existing NICE Version 1.1, the management server 10 manages the devices 11 and the App apparatuses 12 in association with user accounts, but does not have information in which the devices 11 and the App apparatuses 12 are associated with each other directly. Therefore, the management server 60, which executes the second access control method, manages the devices 61 and the App apparatuses 62 in association with user accounts, and also manages the devices 61 and the App apparatuses 62 in association with each other. In other words, the management server 60 manages the correspondence between the devices 61 and the App apparatuses 62 in the same manner as the NICE Version 1.0.1.

In second access information, the AppControl object and the DeviceControl object provided from the management server 60 to each device 61 and each App apparatus 62 are the same as those in the existing NICE Version 1.0.1.

The second access control method differs from the first access control method in that each App apparatus 62 provides to the DS 63 a device list (DeviceList object) that is a list of devices 61 associated with the App apparatus 62. This device list is different from the DeviceList object supplied from the management server 60 to each App apparatus 62 in the existing NICE Version 1.0.1.

The DS 63 refers to the device list (DeviceList object) provided from each App apparatus 62, and makes a request for access information for connecting to the device 61 to the management server 60. In response to the request from the DS 63, the management server 60 transmits to the DS 63 access information for the DS 63 to connect to the device 61. This access information corresponds to, for example, an AppControl object in the NICE Version 1.0.1, and can be used by modifying the existing App Control object.

In response to a request from the device 61 or the DS 63, the DPC 64 transmits a SceneMode object, which is operation instruction information, to the device 61 or the DS 63. At this time, for each App apparatus 62, the DPC 64 transmits the SceneMode object to the DS 63.

### Second Access Control Flow for NICE Version 1.1

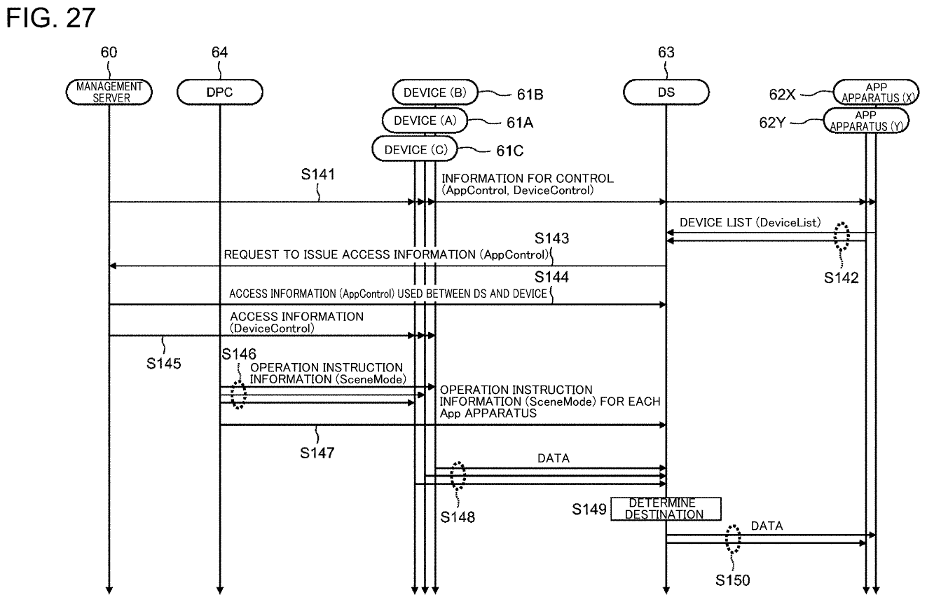

Referring to a flowchart of FIG. 27, second access control processing by the data processing system 51 for the NICE Version 1.1 will be described.

First, in step S141, the management server 60 transmits information for control to each entity, that is, the devices 61A to 61C, the App apparatuses 62X and 62Y, and the DS 63, in response to a request from the entity. Specifically, as described with reference to FIG. 2, a DeviceControl object is provided to the devices 61A to 61C, and an AppControl object is provided to the App apparatuses 62X and 62Y. To the DS 63, an AppControl object and a DeviceControl object are provided. Here, the AppControl object provided to the App apparatuses 62X and 62Y includes not only information for the App apparatus 62 to communicate with the DS 63, but also information for the DS 63 to communicate with the device 61, which is a communication partner as a subcontractor of the App apparatus 62.

In step S141, as the AppControl object supplied as information for control from the management server 60 to the App apparatus 62X, the example of the AppControl object illustrated in FIG. 11 can be applied. As the DeviceControl object supplied to the DS 63 from the management server 60, the example of the DeviceControl object in FIG. 15 or FIG. 16 including information for communicating with Management I/F of each App apparatus 62 can be applied.

In step S142, the App apparatus 62X transmits to the DS 63 a device list (DeviceList object), which is a list of devices 61 whose authorities are to be transferred to the DS 63. Similarly, in step S142, the App apparatus 62Y transmits to the DS 63 a device list (DeviceList object) which is a list of devices 61 whose authorities are to be transferred to the DS 63. The device list from the App apparatus 62X lists the devices 61A and 61B, and the device list from the App apparatus 62Y lists the devices 61A and 61C. As the device list provided to the DS 63, the example of the DeviceList object illustrated in FIG. 25 can be applied.

In step S143, the DS 63 requests the management server 60 to issue access information to the device(s) 61, which are listed in the device list and are the authority transfer target(s). To the access information issue request in step S143, the example of GetAppControl in FIG. 12 described in the first access control processing for the NICE Version 1.0.1 can be applied.

In step S144, the management server 60 refers to the association information managed by the management server 60, and confirms that the DS 63 which is the authority transfer destination and the device 61 which is the access information request target, which are described in the access information issue request command from the DS 63, are associated with the App apparatus 62 which is the authority transfer source. Then, the management server 60 transmits access information to be used between the DS 63, which is the requester, and the device 61, which is the access destination.

In step S145, the management server 60 transmits a DeviceControl object in response to a request from each device 61, thereby transmitting to each device 11 access information for each device 61 to communicate with the DS 63. As an example of the DeviceControl object supplied from the management server 60 to the device 61A, the example of the DeviceControl object in FIG. 17 can be applied.

After step S145, then in step S146, each device 61 makes a request for a SceneMode object as operation instruction information to the DPC 64, and acquires the SceneMode object from the DPC 64. The DPC 64 instructs the operation by transmitting a SceneMode object in response to a request from each device 61.

Subsequently, in step S147, the DS 63 makes a request for a SceneMode object as operation instruction information to the DPC 64, and acquires the SceneMode object from the DPC 64. The DPC 64 instructs the operation by transmitting a SceneMode object in response to a request from the DS 63. At this time, the DS 63 transmits a SceneMode object to each App apparatus 62. For example, the DS 63 transmits GetSceneMode specifying the App apparatus 62 illustrated in FIG. 22 to the DPC 64 to acquire a SceneMode object for each App apparatus 62.

The DS 63 can acquire the control information for control from the management server 60 in step S141, the access information from each App apparatus 62 in step S144, and the operation instruction information in step S147, thereby recognizing the correspondence of device 61—App apparatus 62—SceneMode.

In step S148, each device 61 executes an operation based on the SceneMode object, such as human detection or moving object detection, and transmits data as the detection result by using SetSceneData or SetSceneMark.

In step S149, the DS 63 acquires the data transmitted from each device 61 and determines the App apparatus 62 to which the data is to be transmitted, and in step S150 transmits the data to the determined App apparatus 62 by using SceneData or SceneMark. As with the NICE Version 1.0.1 described above, the data object includes operation instruction identification information indicating which operation instruction (SceneMode object) the data has been detected based on, as in SceneMark in FIG. 18 and DataSection in FIG. 19.

The second access control method by the data processing system 51 for the NICE Version 1.1 is performed as described above.

As described above, in the second access control method, the DS 63 acquires, directly from the management server 60, access information for the DS 63 to connect to the device 61 associated with the App apparatus 62. The DS 63 can acquire a device list (DeviceList object) from the App apparatus 62, thereby recognizing the device(s) 61 associated with the App apparatus 62, that is, recognizing the correspondence between the App apparatus 62 and the device(s) 61, and accordingly, acquires, directly from the management server 60, access information for the DS 63 to connect to the device(s) 61.

### 8. Case Where Plurality of DSs are Interposed

Next, a case where a plurality of DSs 63 are interposed between a device 61 and an App apparatus 62 will be described.

In the NICE standard, it is possible that there are a plurality of DSs 63 interposed between the device 61 and the App apparatus 62. How the above-described first and second access control methods can handle such a case will be described.

### For NICE Version 1.0.1

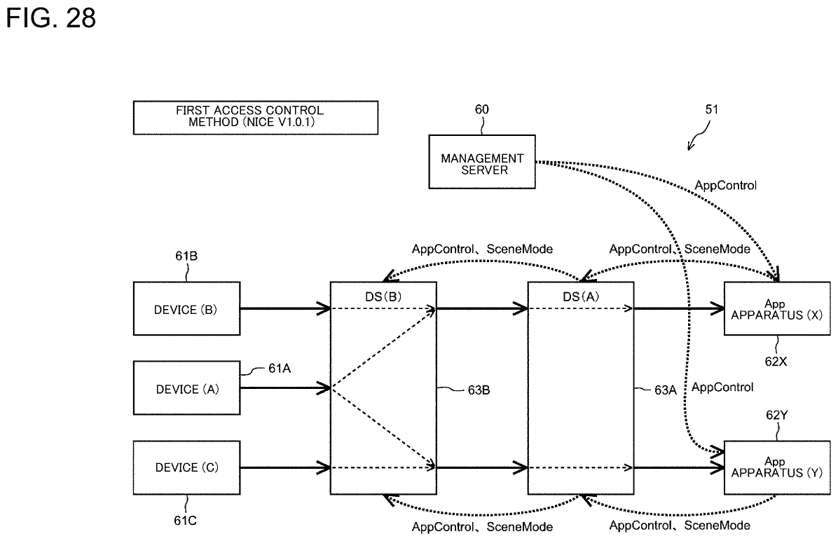

FIG. 28 is a diagram illustrating, for the NICE Version 1.0.1, a case where two DSs 63: DSs 63A and 63B are interposed between devices 61 and App apparatuses 62, and the first access control method described above is used to control them.

For the NICE Version 1.0.1, in the first access control method described above, an App apparatus 62 acquires access information (AppControl object) of a device 61 associated with the App apparatus 62 and the App apparatus 62 from the management server 60, and transmits access information for the DS 63 to connect to the device 61 associated with the App apparatus 62 from the App apparatus 62 to the DS 63. The App apparatus 62 also transmits a SceneMode object, which is operation instruction information, to the DS 63 to instruct the operation.

Therefore, access information and operation instruction information of the device 61 associated with the App apparatus 62 is supplied to the DS 63A from the App apparatus 62X or 62Y by using the AppControl object and the SceneMode object.

Similarly, access information and operation instruction information of the device 61 associated with the App apparatus 62 is supplied to the DS 63B from the DS 63A by using the AppControl object and the SceneMode object.

At this time, it is necessary for the DS 63B to be able to identify data for the App apparatus 62X and data for the App apparatus 62Y among the data acquired from each device 61, and transmit the data to the DS 63A. In addition, the DS 63A needs to be able to identify data for the App apparatus 62X and data for the App apparatus 62Y among the data acquired from the DS 63B, and transmit the data to the App apparatus 62X or the App apparatus 62Y.

### For NICE Version 1.1

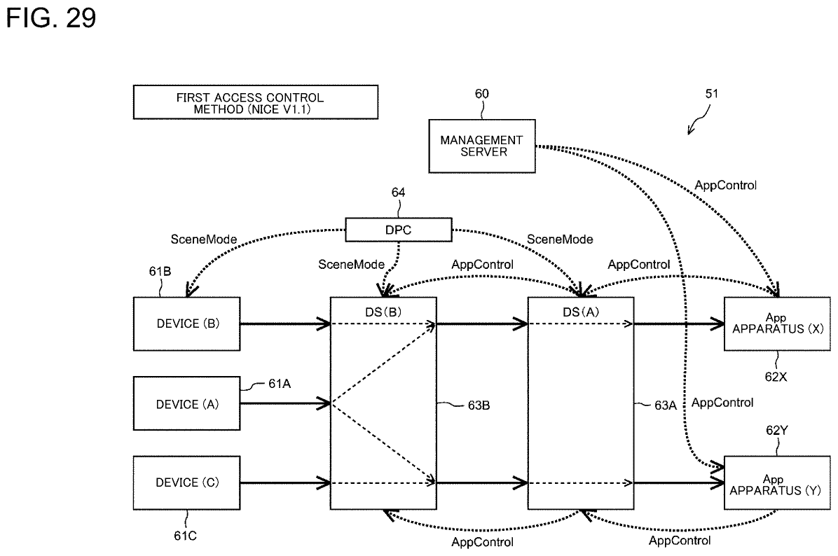

FIG. 29 is a diagram illustrating, for the NICE Version 1.1, a case where two DSs 63: DSs 63A and 63B are interposed between devices 61 and App apparatuses 62, and the first access control method described above is used to control them.

For the NICE Version 1.1, in the first access control method described above, an App apparatus 62 acquires access information (AppControl object) of a device 61 associated with the App apparatus 62 and the App apparatus 62 from the management server 60, and transmits access information for the DS 63 to connect to the device 61 associated with the App apparatus 62 from the App apparatus 62 to the DS 63. A SceneMode object, which is operation instruction information, is supplied from the DPC 64 to the DS 63.

Thus, access information of the device 61 associated with the App apparatus 62 is supplied to the DS 63A from the App apparatus 62X or 62Y by using an AppControl object. Similarly, access information of the device 61 associated with the App apparatus 62 is supplied to the DS 63B from the DS 63A by using an AppControl object. Operation instruction information is supplied to the DS 63A from the DPC 64 by using a SceneMode object. Similarly, operation instruction information is supplied to the DS 63B from the DPC 64 by using a SceneMode object.

At this time, it is necessary for the DS 63B to be able to identify data for the App apparatus 62X and data for the App apparatus 62Y among the data acquired from each device 61, and transmit the data to the DS 63A. In addition, it is necessary for the DS 63A to be able to identify data for the App apparatus 62X and data for the App apparatus 62Y among the data acquired from the DS 63B, and transmit the data to the App apparatus 62X or the App apparatus 62Y.

### For NICE Version 1.0.1

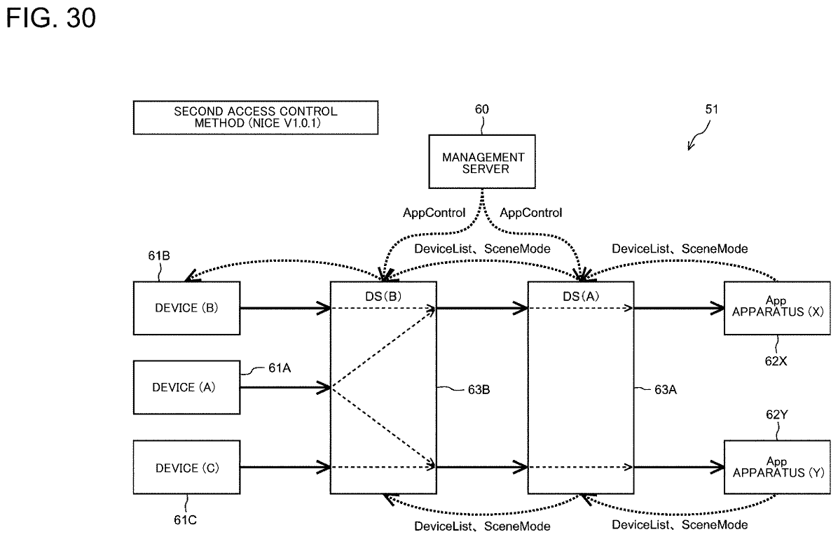

FIG. 30 is a diagram illustrating, for the NICE Version 1.0.1, a case where two DSs 63: DSs 63A and 63B are interposed between devices 61 and App apparatuses 62, and the second access control method described above is used to control them.

For the NICE Version 1.0.1, in the second access control method described above, an App apparatus 62 transmits to the DS 63 a device list (DeviceList object), which is a list of devices 61 associated with the App apparatus 62. The App apparatus 62 also transmits to the DS 63 a SceneMode object, which is operation instruction information, to instruct the operation. The DS 63 refers to the device list, makes a request for access information to the management server 60, and acquires access information (AppControl object) for the DS 63 to connect to the device 61 from the management server 60 accordingly.

Thus, a list of devices 61 is supplied to the DS 63A from the App apparatus 62X or 62Y by using a DeviceList object, and a SceneMode object, which is operation instruction information, is also supplied. Access information (AppControl object) for the DS 63A to connect to the device 61 is supplied from the management server 60 to the DS 63A. Similarly, a list of devices 61 is supplied to the DS 63B from the DS 63A by using the DeviceList object, and a SceneMode object, which is operation instruction information, is also supplied. Access information (AppControl object) for the DS 63B to connect to the device 61 is supplied from the management server 60 to the DS 63B.

At this time, it is necessary for the DS 63B to be able to identify data for the App apparatus 62X and data for the App apparatus 62Y among the data acquired from each device 61, and transmit the data to the DS 63A. In addition, it is necessary for the DS 63A to be able to identify data for the App apparatus 62X and data for the App apparatus 62Y among the data acquired from the DS 63B, and transmit the data to the App apparatus 62X or the App apparatus 62Y.

### For NICE Version 1.1

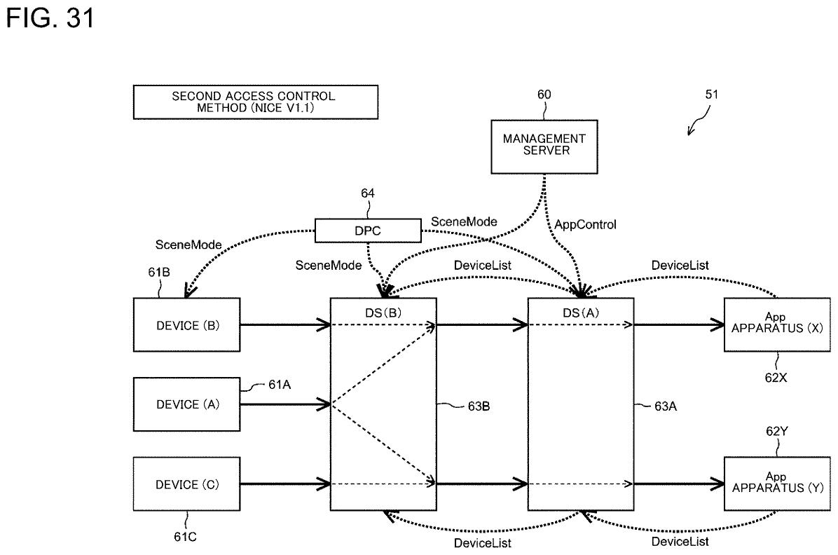

FIG. 31 is a diagram illustrating, for the NICE Version 1.1, a case where two DSs 63: DSs 63A and 63B are interposed between devices 61 and App apparatuses 62, and the second access control method described above is used to control them.

For the NICE Version 1.1, in the second access control method described above, an App apparatus 62 provides to the DS 63 a device list (DeviceList object), which is a list of devices 61 associated with the App apparatus 62. The DS 63 refers to the device list (DeviceList object) provided from each App apparatus 62, makes a request for access information (AppControl object) for connecting to the device 61 to the management server 60, and acquires the access information from the management server 60 accordingly. A SceneMode object, which is operation instruction information, is supplied from the DPC 64 to the DS 63.

Thus, a device list (DeviceList object) is supplied to the DS 63A from the App apparatus 62X or 62Y, and access information (AppControl object) is supplied from the management server 60. Operation instruction information is supplied to the DS 63A from the DPC 64 by using a SceneMode object. Similarly, a device list (DeviceList object) is supplied to the DS 63B from the DS 63A, and access information (AppControl object) is supplied from the management server 60. Operation instruction information is supplied to the DS 63B from the DPC 64 by using a SceneMode object.

At this time, it is necessary for the DS 63B to be able to identify data for the App apparatus 62X and data for the App apparatus 62Y among the data acquired from each device 61, and transmit the data to the DS 63A. In addition, it is necessary for the DS 63A to be able to identify data for the App apparatus 62X and data for the App apparatus 62Y among the data acquired from the DS 63B, and transmit the data to the App apparatus 62X or the App apparatus 62Y.

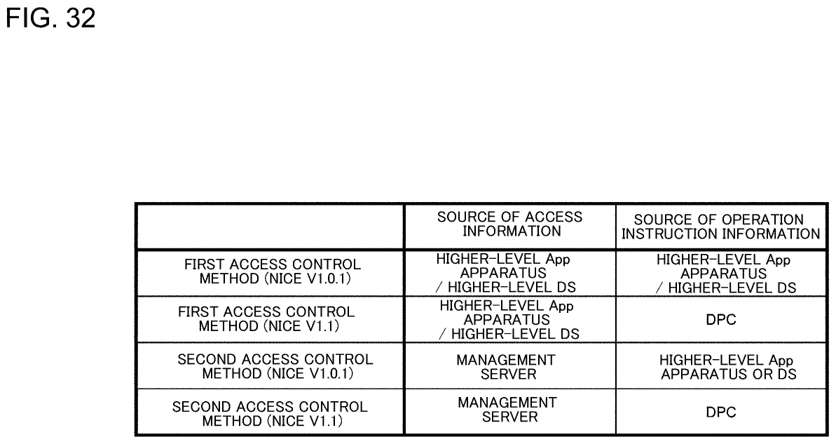

FIG. 32 is a table that summarizes the sources of access information (AppControl object) and operation instruction information (SceneMode object) to be provided in the first access control method and the second access control method for each of the NICE Version 1.0.1 and NICE Version 1.1.

Since two sets of access information (AppControl object) and operation instruction information (SceneMode object) are provided, one for the App apparatus 62X and the other for the App apparatus 62Y, it is necessary to maintain the correct combination of access information and operation instruction information for each App apparatus 62.

Therefore, in the first access control method and the second access control method, the operation instruction information (SceneMode object) can be configured to include information for identifying which App apparatus 62 the operation instruction information is for, specifically whether it is for the App apparatus 62X or for the App apparatus 62Y.

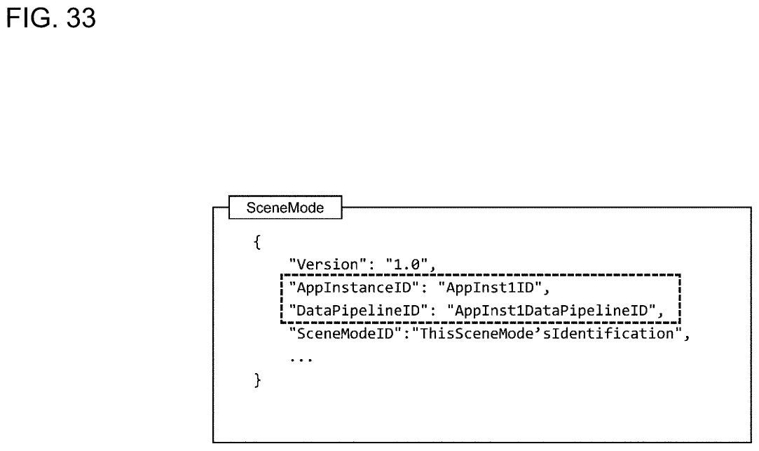

Specifically, as illustrated in FIG. 33, “AppInstanceID”, which is identification information (apparatus identification information) for identifying an App apparatus 62, and “DataPipelineID”, which is identification information (data pipeline identification information), are added to the existing SceneMode object. If there is only one data pipeline for a single App apparatus 62, the data pipeline identification information may not be used, and only the apparatus identification information may be used. This allows the DS 63A and the DS 63B to recognize what data to transmit to the App apparatus 62X or the App apparatus 62Y, and therefore allows them to identify data for the App apparatus 62X and data for the App apparatus 62Y and transmit them to a higher-level apparatus.

### 9. Summary of Data Processing System According to First Embodiment

In the data processing system 51 according to the first embodiment, each device 61 transmits data acquired by a sensor to the DS 63 either as it is or after performing a predetermined data processing on the data. The DS 63 acquires association information between devices 61 and App apparatuses 62, and based on the acquired association information, determines a destination(s) of data acquired from one or more devices 61, and transmits the data to the one or more App apparatuses 62 determined as the destination(s). In the first access control method described above, the association information between devices 61 and App apparatuses 62 is acquired from an App apparatus 62. On the other hand, in the first access control method described above, the association information between devices 61 and App apparatuses 62 is acquired from the management server 60. This allows the DS(s) 63 interposed between the devices 61 and the App apparatuses 62 to appropriately provide data from each device 61 to the plurality of App apparatuses 62.

### 10. Data Processing System According to Second Embodiment

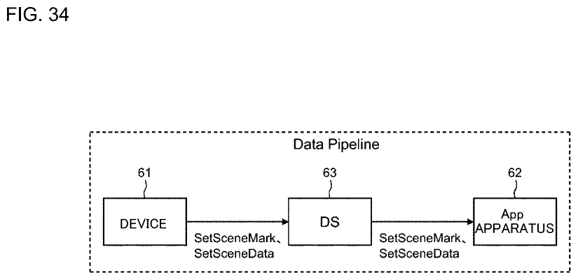

In the data processing system 51 described above, as illustrated in FIG. 34, a data pipeline is configured in which data is transferred from the device 61 to the DS 63 and data is transferred from the DS 63 to the App apparatus 62. The data pipeline is a flow of data between entities using Data API defined in the NICE standard. Data API is an API for data transfer, such as SetSceneData and SetSceneMark described above.

The communication interface of the current NICE standard specifies the following security measures: transmission path protection using TLS and client authentication using an OAuth2-based access token. Specifically, in TLS communication between entities, only server authentication is performed; client authentication is not performed at the TLS layer, but is realized by using an access token specified in the NICE application layer. As described above, the access token is delivered to the transmitting side by using a SceneMode object, and the access token is set as a parameter for SetSceneMark or SetSceneData, which is a Data API. The server-side entity authenticates the client by checking the claims (descriptions of the transmitting destination, source, etc.) in the access token.

However, for data transmission using SetSceneMark or SetSceneData, which are a Data API, only one-way data communication from the device 61 to the App apparatus 62 or the DS 63 is defined, and any authentication method for two-way data communication is not clearly specified. In future NICE standards, it is expected that two-way data communication will also be required. Therefore, an authentication method for two-way data communication will be proposed herein.

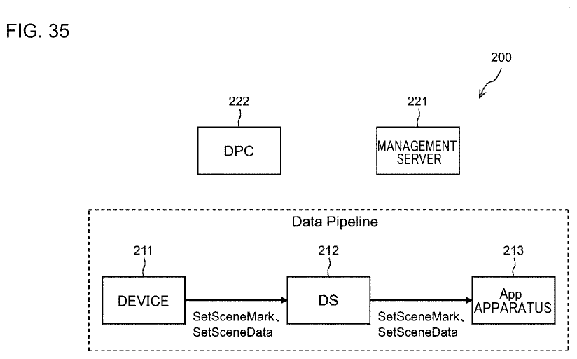

FIG. 35 is a block diagram illustrating a configuration example of a data processing system according to a second embodiment of the present disclosure, which realizes an authentication method for two-way data communication.

The data processing system 200 illustrated in FIG. 35 includes a device 211, a DS 212, an App apparatus 213, a management server 221, and a DPC 222.

The device 211, the DS 212, and the App apparatus 213 are entities that configure a data pipeline, and correspond to the device 61, the DS 63, and the App apparatus 62 of the data processing system 51 described above, respectively. However, they differ from the entities of the data processing system 51 described above and the entities of the current NICE standard in that they realize authentication (mutual authentication) of both the client-side entity and the server-side entity in authentication during data transmission between the entities.

Similarly to the management server 60 described above, the management server 221 manages the device(s) 61 and the App apparatus(es) 62 in association with user accounts. The management server 221 also has a function of transmitting a DeviceControl object to the device 211, a function of transmitting an AppControl object and a DeviceControl object to the DS 212, and a function of transmitting an AppControl object to the App apparatus 213. Hereinafter, the AppControl object and the DeviceControl object will be collectively referred to as the Control object.

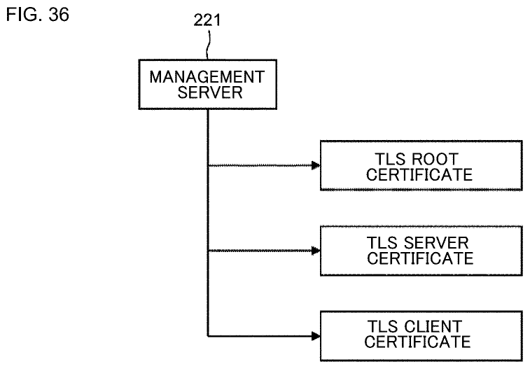

Furthermore, the management server 221 has a function of issuing a group of certificates required for Transport Layer Security (TLS) communication to the entities: the device 211, the DS 212, and the App apparatus 213. Specifically, as illustrated in FIG. 36, the management server 221 can issue its own TLS root certificate, TLS server certificate, and TLS client certificate. Since the current NICE standard system has a mechanism for issuing X.509 certificates using public key cryptography, this mechanism is expanded so that the management server 221 issues its own TLS root certificate, TLS server certificate, and TLS client certificate. The management server 221 distributes its own TLS root certificate to each entity. The management server 221 also provides (transmits) the issued TLS client certificate and TLS server certificate to the DPC 222.

In the data processing system 51 described above, the management server 60 has been described as being compatible with the NICE License Authority and NICE Account Service (LA/AS) in the NICE standard. However, the management server 221 of the data processing system 200 need only be compatible with the NICE AS. Of course, the management server 221 may be compatible with the NICE LA/AS.

Similarly to the DPC 64 described above, the DPC 222 transmits a SceneMode object to the device 211 and the DS 212 to instruct the operations of the device 211 and the DS 212. Since the DPC 222 is in a position to instruct the operation, when two entities communicate data with each other, the DPC 222 knows which of the two entities serves as a client-side entity and which serves as a server-side entity. Therefore, the DPC 222 distributes (transmits) the TLS client certificate or TLS server certificate acquired from the management server 221 according to the role of each entity. The TLS client certificate is distributed to the client-side entity, and the TLS server certificate is distributed to the server-side entity. If an entity can serve as both the client-side entity and the server-side entity, then both the TLS client certificate and the TLS server certificate are distributed. Once the entity's role has been determined, data is transmitted from the client-side entity to the server-side entity by using Data API of SetSceneMark or SetSceneData.

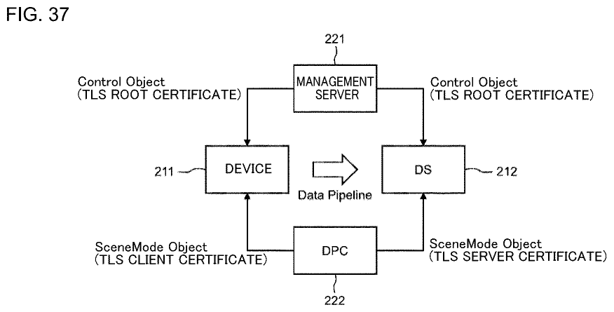

With reference to FIG. 37, an example will be described in which data communication is performed between the device 211 and DS 212 entities for the distribution of TLS certificates to the entities. In the example of FIG. 37, it is assumed that data is transmitted from the device 211 to the DS 212.

Each entity of the device 211 and the DS 212 connects to the management server 221 at startup, and receives a Control object from the management server 221.

With respect to the specific Control object to be received, the client-side entity receives an AppControl object, and the server-side entity receives a DeviceControl object. The Control object has a property called AllowedTLSRootCertificates. The management server 221 sets its own TLS root certificate in the AllowedTLSRootCertificates property of the Control object, and transmits the resulting property to the device 211 and the DS 212, thereby distributing the TLS root certificate required for TLS communication to the device 211 and the DS 212.

Each entity of the device 211 and the DS 212 receives a SceneMode object from the DPC 222 to acquire an operation instruction. The SceneMode object has a property called EndPoint for specifying a data transmission destination. The DPC 222 sets an identifier indicating the role of a client-side entity (TLS client) or a server-side entity (TLS server) and a certificate for the role (i.e., a TLS server certificate or a TLS client certificate) in the EndPoint property, and transmits the resulting property to the device 211 and the DS 212, thereby distributing the TLS server certificate or the TLS client certificate to the device 211 and the DS 212. In this example, since data is transmitted from the device 211 to the DS 212, an identifier indicating the role of the client-side entity (TLS client) and a TLS client certificate are set in the EndPoint property of the SceneMode object of the device 211. On the other hand, an identifier indicating the role of the server-side entity (TLS server) and a TLS server certificate are set in the EndPoint property of the SceneMode object of the DS 212. A SceneMode object whose EndPoint property includes an identifier indicating the role of the client-side entity (TLS client) or the server-side entity (TLS server) and a TLS server certificate or a TLS client certificate for that role is a new feature that is not specified in the current NICE standard.

### 11. Flowchart of Authentication Processing

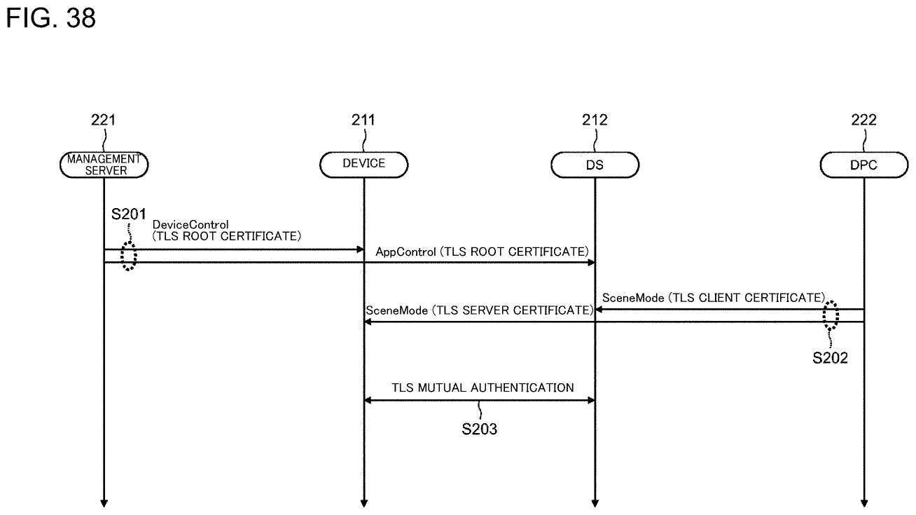

Referring to a flowchart of FIG. 38, the following describes the distribution of a TLS server certificate and a TLS client certificate, and authentication processing for performing TLS mutual authentication using the distributed certificates. This processing is started, for example, when the device 211 and the DS 212 start up.

First, in step S201, the management server 221 transmits a DeviceControl object to the device 211 in response to a request from the device 211. The AllowedTLSRootCertificates property of the DeviceControl object includes a TLS root certificate. In step S201, the management server 221 transmits a DeviceControl object to the DS 212 in response to a request from the DS 212. The AllowedTLSRootCertificates property of the DeviceControl object includes the TLS root certificate.

In step S202, the DPC 222 transmits a SceneMode object to the device 211 in response to a request from the device 211. The EndPoint property of the SceneMode object transmitted to the device 211 includes an identifier indicating the role of a client-side entity (TLS client) and a TLS client certificate. Also in step S202, the DPC 222 transmits a SceneMode object to the DS 212 in response to a request from the DS 212. The EndPoint property of the SceneMode object transmitted to the DS 212 includes an identifier indicating the role of a server-side entity (TLS server) and a TLS server certificate.

In step S203, the device 211 and the DPC 222 perform TLS mutual authentication using the TLS root certificate and the TLS client certificate or the TLS server certificate that they hold. Specifically, the device 211, which is a TLS client, makes a request for a server certificate to the DPC 222, and verifies the acquired server certificate using the TLS root certificate to authenticate the DPC 222. Next, the DPC 222, which is a TLS server, makes a request for a TLS client certificate to the device 211, which is a TLS client, and verifies the acquired TLS client certificate using the TLS root certificate to authenticate the device 211.

When the TLS mutual authentication is completed and the device 211 and the DPC 222 are authenticated by each other, data is transmitted from the client-side entity to the server-side entity by using SetSceneMark and SetSceneData over a TLS communication path encrypted with a common key.

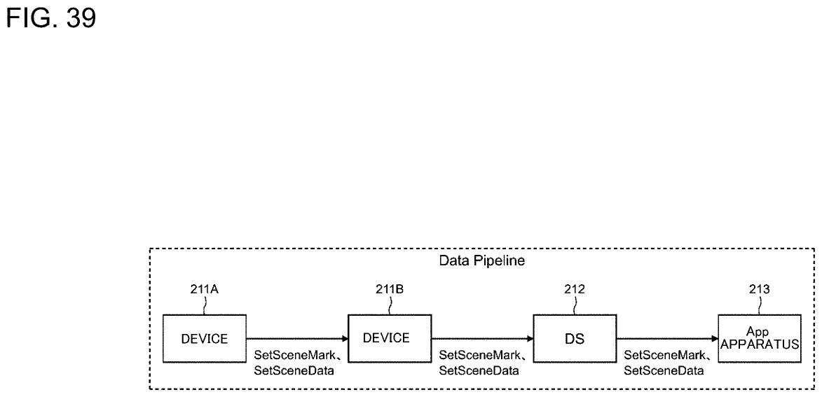

Incidentally, a data pipeline configuration in the NICE standard may also be such that, as illustrated in FIG. 39, two devices 211: a device 211A and a device 211B, are connected in series, and data is transferred in the order of the device 211A, the device 211B, a DS 212, and an App apparatus 213 by using SetSceneMark and SetSceneData.

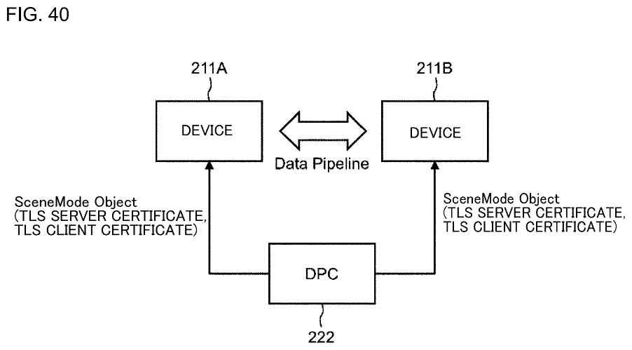

Alternatively, as illustrated in FIG. 40, a case may be given in which two-way data communication is performed between a device 211A and a device 211B.

As illustrated in FIG. 40, when the device 211A and the device 211B perform two-way data communication, each of the device 211A and the device 211B plays the role of both a TLS client and a TLS server. When each of the device 211A and the device 211B may serve as both a TLS client and a TLS server, then in step S202 of the authentication processing described in FIG. 38, the DPC 222 may include, in the EndPoint property of a SceneMode object, two identifiers: an identifier indicating the role of a TLS client and an identifier indicating the role of a TLS server, and both a TLS client certificate and a TLS server certificate, and transmit the resulting property to each of the devices 211A and 11B. This makes it possible to realize two-way communication between devices, which is not specified in the current NICE standard.

### 12. Summary of Data Processing System According to Second Embodiment

As described above, in the data processing system 200 according to the second embodiment, the DPC 222 uses a SceneMode object to transmit, to two entities communicating data, at least one identifier for identifying the role of a TLS client or a TLS server, and a TLS certificate for that identifier. The two entities perform TLS mutual authentication using the TLS certificate included in the SceneMode object to authenticate each other in data communication. As a result, authentication is completed when a TLS session is established, eliminating the need for client authentication using an OAuth2-based access token, which is currently performed in the NICE standard, and making it easier to mutually authenticate two-way data communication between entities.

In the above-described examples, an example has been described in which the current SceneMode object of the NICE standard is modified to store, in the SceneMode object, at least one of a TLS client certificate or a TLS server certificate, and at least one of an identifier indicating the role of the TLS client or TLS server, and the resulting object is distributed to each entity. However, the method of distributing the certificate(s) and identifier(s) is not limited to using the SceneMode object, and other objects may be used. For example, a new object may be defined and used to store the certificate and identifier of a TLS client or TLS server so that the resulting object is distributed.

The data processing system 200 is configured such that the management server 221 distributes the TLS root certificate, and the DPC 222 distributes the TLS client certificate and the TLS server certificate. However, it may be configured such that one device distributes the TLS root certificate, the TLS client certificate, and the TLS server certificate. In other words, the management server 221 and the DPC 222 may be physically configured as one device.

### 13. Hardware Configuration Example

Next, a hardware configuration example of an entity included in the data processing system 51 according to the first embodiment described above or the data processing system 200 according to the second embodiment described above will be described.

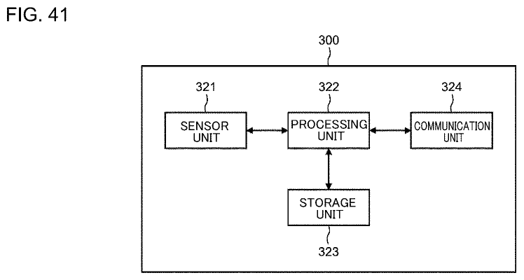

FIG. 41 is a block diagram illustrating a configuration example of a device (device apparatus) 300 that can be used as the device 61 of the data processing system 51 or the device 211 of the data processing system 200.

The device 300 includes a sensor unit 321, a processing unit 322, a storage unit 323, and a communication unit 324.

The sensor unit 321 acquires sensing data and outputs the acquired sensing data to the processing unit 322. For example, in a case where the device 300 is an imaging device, the sensor unit 321 includes an imaging optical system such as an imaging lens and a zoom lens that collect light emitted from a subject, and an imaging element such as a charge coupled device (CCD) image sensor or a complementary metal oxide semiconductor (CMOS) image sensor.

The sensor unit 321 may also be configured to have a subject recognition function. For example, if the subject recognition function has a function of recognizing the type of an imaged object, the sensor unit 321 may output information indicating the recognition result as sensing data. For example, the sensor unit 321 outputs text data indicating the type of the recognized object as sensing data. Alternatively, the subject recognition function may have a function of counting the number of specified objects or a function of counting the number of people in a specific state (e.g., the number of people in a talking state). In this case, text data indicating the number of objects or people may be output as sensing data.

The sensor unit 321 may include a Time of Flight (ToF) sensor as a depth sensor (distance measurement sensor) in addition to or instead of the imaging device. The ToF sensor can directly or indirectly measure the return time of reflected light from a subject, thereby acquiring the distance between the ToF sensor and the subject and shape information such as unevenness (depth information/image).

The sensor unit 321 may also include a positioning sensor such as an infrared (IR) camera or a Global Navigation Satellite System (GNSS) sensor, a temperature sensor, a sound collection device (microphone), an air pressure sensor, a humidity sensor, a wind direction and speed sensor, a sunshine sensor, a precipitation sensor, a water level sensor, a seismic intensity sensor (a sensor that detects the seismic intensity of an earthquake), and the like. The sensor unit 321 is not particularly limited as long as it can acquire sensing data from the surrounding environment (sensing environment). The sensor unit 321 may be fixedly provided within the device 300, or may be detachably provided with respect to the device 300.

The processing unit 322 is configured by, for example, a microcomputer having processing circuits such as a CPU and a graphics processing unit (GPU), a ROM, a RAM, and the like. The processing unit 322 functions as a control unit that performs overall control of the device 300 by executing processing based on a program stored in a storage device such as a ROM. The processing unit 322 also has a function of processing the sensing data acquired by the sensor unit 321 and generating transmission data.

The storage unit 323 stores programs and information for the processing unit 322 to execute various processing, as well as information obtained by the processing. For example, the storage unit 323 can be used for temporarily storing information output by the sensor unit 321, such as sensing data. The storage unit 323 is realized by a storage device such as a solid state drive (SSD) or a hard disk drive (HDD).

The communication unit 324 can transmit and receive data to and from an external device that is another entity. The communication unit 324 is, for example, a communication interface having a function of transmitting and receiving data.

As described above, each functional unit such as the processing unit 322 may be configured using both or either of hardware and software. That configuration is not particularly limited. For example, each functional unit described above may be implemented by a computer such as a CPU or an MPU executing a program stored in advance in a ROM by using a RAM or the like as a working area. Each functional unit may be implemented by an integrated circuit such as an ASIC or an FPGA.

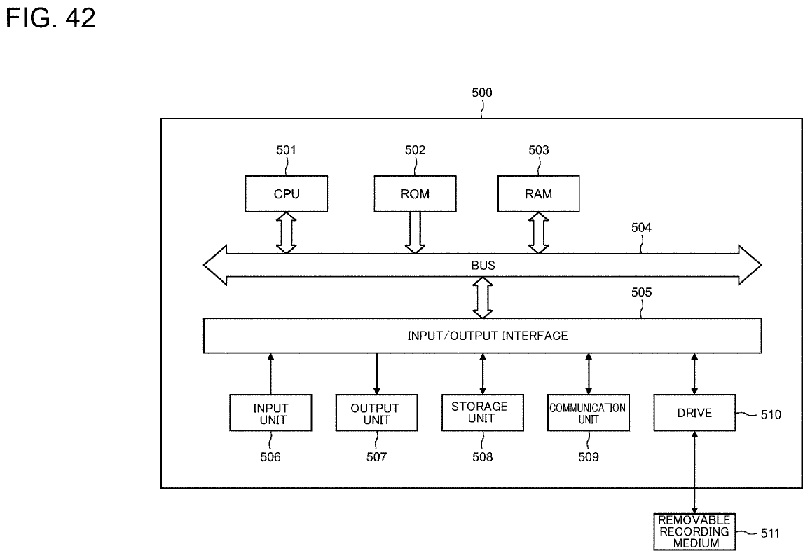

FIG. 42 is a block diagram illustrating a hardware configuration example of a computer 500 serving as an information processing apparatus that can be used as the management server 60, the App apparatus 62, the DS 63, or the DPC 64 of the data processing system 51, or the DS 212, the App apparatus 213, the management server 221, or the DPC 222 of the data processing system 200.

In the computer 500, a central processing unit (CPU) 501, a read only memory (ROM) 502, and a random access memory (RAM) 503 are connected to each other by a bus 504. An input/output interface 505 is further connected to the bus 504. An input unit 506, an output unit 507, a storage unit 508, a communication unit 509, and a drive 510 are connected to the input/output interface 505.

The input unit 506 includes a keyboard, a mouse, a microphone, or the like. The output unit 507 includes a display, a speaker, or the like. The storage unit 508 includes a hard disk, non-volatile memory, or the like. The communication unit 509 includes a network interface or the like. The drive 510 drives a removable recording medium 511 such as a magnetic disk, an optical disc, a magneto-optical disk, or a semiconductor memory.

In the computer 500 configured as described above, for example, the CPU 501 loads a program recorded in the storage unit 508 into the RAM 503 via the input/output interface 505 and the bus 504 and executes the program to perform the series of processes described above. The CPU 501 functions as a control unit for the computer 500 operating as an information processing apparatus. The RAM 503 also appropriately stores data and the like necessary for the CPU 501 to execute various types of processing.

The program executed by (the CPU 501 of) the computer 500 can be recorded on, for example, the removable recording medium 511 serving as a package medium for supply. The program can also be provided via a wired or wireless transmission medium such as a local area network, the Internet, or digital satellite broadcasting.

In the computer 500, by mounting the removable recording medium 511 on the drive 510, it is possible to install the program in the storage unit 508 via the input/output interface 505. The program can be received by the communication unit 509 via a wired or wireless transfer medium to be installed in the storage unit 508. In addition, the program may be installed in advance in the ROM 502 or the storage unit 508.

The program executed by a computer 500 may be a program that performs processing chronologically in the order described in the present specification or may be a program that performs processing in parallel or at a necessary timing such as a called time.

In the present specification, the steps indicated in each flowchart may of course be performed in time series according to the order described therein, but need not absolutely be performed in time series, and may instead be performed in parallel or at the required timing, such as when called.

In the present specification, a system means a set of a plurality of constituent elements (apparatuses, modules (components), or the like) and all the constituent elements may or may not be included in a same casing. Accordingly, a plurality of apparatuses accommodated in separate casings and connected via a network and one apparatus in which a plurality of modules are accommodated in one casing both constitute systems.

The embodiments of the present disclosure are not limited to the above-described embodiments, and various modifications can be made without departing from the essential spirit of the technology of the present disclosure.

For example, a combination of all or part of the plurality of embodiments described above may be employed.

For example, the present technology may be configured as cloud computing in which a plurality of apparatuses share and cooperatively process one function via a network.

In addition, each step described in the above flowchart can be executed by one apparatus or executed in a shared manner by a plurality of apparatuses. Furthermore, in a case where a plurality of steps of processing are included in one step, the plurality of steps of processing included in one step may be executed by one apparatus or by a plurality of apparatuses in a shared manner.

The advantageous effects described in the present specification are merely exemplary and are not limited, and other advantageous effects of the advantageous effects described in the present specification may be achieved.

The technology of the present disclosure can be configured as follows.
(1)

An information processing apparatus including: a control unit that acquires, for a plurality of application apparatuses, association information between a device that outputs data and each of the application apparatuses that performs predetermined data processing using the data, determines a destination of the data acquired from one or more of the devices, based on the acquired association information, and controls transmission of the data to one or more of the application apparatuses determined as the destination.
(2)

The information processing apparatus according to (1), wherein the control unit acquires the association information from the application apparatus.
(3)

The information processing apparatus according to (1) or (2), wherein the control unit acquires, from the application apparatus, access information for the information processing apparatus to connect to the device associated with the application apparatus, as the association information.
(4)

The information processing apparatus according to (3), wherein the application apparatus acquires, from a server apparatus that manages the association information, access information for the information processing apparatus to connect to the device.
(5)

The information processing apparatus according to (3) or (4), wherein the application apparatus acquires, from a server apparatus that manages the association information, access information for the application apparatus to connect to the device associated with the application apparatus, and, based on the acquired access information for the application apparatus to connect, makes a request, to the server apparatus, for access information for the information processing apparatus to connect to the device to acquire the access information.
(6)

The information processing apparatus according to (1), wherein the control unit acquires the association information from a server apparatus that manages the association information.
(7)

The information processing apparatus according to (6), wherein the control unit acquires from the application apparatus a device list of the devices associated with the application apparatus, and, based on the device list, acquires the association information from a server apparatus that manages the association information.
(8)

The information processing apparatus according to (6) or (7), wherein the control unit acquires from the application apparatus a device list of the devices associated with the application apparatus, and, based on the device list, makes a request, to the server apparatus, for access information for the information processing apparatus to connect to the devices to acquire the access information.
(9)

The information processing apparatus according to (7) or (8), wherein the application apparatus transmits the device list to the information processing apparatus, based on the access information, acquired from the server apparatus, for the application apparatus to connect.
(10)

The information processing apparatus according to any one of (1) to (9), wherein access information for the information processing apparatus to connect to the device includes data pipeline identification information for identifying a data pipeline.
(11)

The information processing apparatus according to any one of (1) to (10), wherein access information for the application apparatus to connect to the device associated with the application apparatus includes data pipeline identification information for identifying a data pipeline.
(12)

The information processing apparatus according to any one of (1) to (11), wherein the control unit acquires operation instruction information including apparatus identification information for identifying the application apparatus or data pipeline identification information for identifying a data pipeline, and determines a destination of the data, based on the acquired operation instruction information.
(13)

The information processing apparatus according to any one of (1) to (12), wherein the control unit acquires operation instruction information, determines a destination of the data, based on operation instruction identification information for identifying the operation instruction information included in the data acquired from the device, and transmits the data to one or more of the application apparatuses determined as the destination.
(14)

The information processing apparatus according to any one of (1) to (13), wherein the information processing apparatus is Data Service of the NICE standard.
(15)

An information processing method including: by an information processing apparatus,
acquiring, for a plurality of application apparatuses, association information between a device that outputs data and each of the application apparatuses that performs predetermined data processing using the data; determining a destination of the data acquired from one or more of the devices, based on the acquired association information; and transmitting the data to one or more of the application apparatuses determined as the destination.
(16)

A computer-readable recording medium having stored thereon a program for causing a computer to execute processing of:
acquiring, for a plurality of application apparatuses, association information between a device that outputs data and each of the application apparatuses that performs predetermined data processing using the data; determining a destination of the data acquired from one or more of the devices, based on the acquired association information; and transmitting the data to one or more of the application apparatuses determined as the destination.
(17)

An information processing apparatus including: a control unit that controls transmission of an identifier for identifying a role of a TLS client or a TLS server and a TLS certificate in accordance with the identifier, to two entities that communicate data generated by a device.
(18)

The information processing apparatus according to (17), wherein the two entities perform TLS mutual authentication using the TLS certificate transmitted from the information processing apparatus.
(19)

The information processing apparatus according to (17) or (18), wherein the control unit controls transmission of two identifiers for identifying a role of a TLS client and a role of a TLS server, and a TLS client certificate and a TLS server certificate, to each of the two entities.
(20)

The information processing apparatus according to any one of (17) to (19), wherein the identifier and the TLS certificate are included in a SceneMode object and transmitted.
(21)

The information processing apparatus according to any one of (17) to (20), wherein the identifier and the TLS certificate are included in an EndPoint property of a SceneMode object and transmitted.
(22)

The information processing apparatus according to any one of (17) to (21), wherein the information processing apparatus is Data Pipeline Controller of the NICE standard.
(23)

The information processing apparatus according to any one of (17) to (22), wherein at least one of the two entities is a device of the NICE standard.
(24)

The information processing apparatus according to any one of (17) to (23), wherein the two entities are devices of the NICE standard.
(25)

The information processing apparatus according to any one of (17) to (24), wherein the control unit acquires a TLS client certificate and a TLS server certificate that are issued by a management server, and controls transmission of the certificates to the two entities, respectively.
(26)

The information processing apparatus according to (25), wherein the management server is NICE AS of the NICE standard.
(27)

An information processing method including: by an information processing apparatus,
transmitting an identifier for identifying a role of a TLS client or a TLS server and a TLS certificate in accordance with the identifier to two entities that communicate data generated by a device.
(28)

A computer-readable recording medium having stored thereon a program for causing a computer to execute processing of:
transmitting an identifier for identifying a role of a TLS client or a TLS server and a TLS certificate in accordance with the identifier to two entities that communicate data generated by a device.

### REFERENCE SIGNS LIST

51 Data processing system
60 Management server
61 Device
62 App apparatus
63 Device
151 Operation instruction identification information
152 Operation instruction identification information
200 Data processing system
211 Device
213 App apparatus
221 Management server
300 Device
321 Sensor unit
322 Processing unit
323 Storage unit
324 Communication unit
500 Computer
502 ROM
504 Bus
505 Input/output interface
506 Input unit
507 Output unit
508 Storage unit
509 Communication unit
510 Drive
511 Removable recording medium

What is claimed is:

1. An information processing apparatus comprising: a control unit that acquires, for a plurality of application apparatuses, association information between a device that outputs data and each of the application apparatuses that performs predetermined data processing using the data, determines a destination of the data acquired from one or more of the devices, based on the acquired association information, and controls transmission of the data to one or more of the application apparatuses determined as the destination.

2. The information processing apparatus according to claim 1, wherein the control unit acquires the association information from the application apparatus.

3. The information processing apparatus according to claim 1, wherein the control unit acquires, from the application apparatus, access information for the information processing apparatus to connect to the device associated with the application apparatus, as the association information.

4. The information processing apparatus according to claim 3, wherein the application apparatus acquires, from a server apparatus that manages the association information, access information for the information processing apparatus to connect to the device.

5. The information processing apparatus according to claim 3, wherein the application apparatus acquires, from a server apparatus that manages the association information, access information for the application apparatus to connect to the device associated with the application apparatus, and, based on the acquired access information for the application apparatus to connect, makes a request, to the server apparatus, for access information for the information processing apparatus to connect to the device to acquire the access information.

6. The information processing apparatus according to claim 1, wherein the control unit acquires the association information from a server apparatus that manages the association information.

7. The information processing apparatus according to claim 6, wherein the control unit acquires from the application apparatus a device list of the devices associated with the application apparatus, and, based on the device list, acquires the association information from a server apparatus that manages the association information.

8. The information processing apparatus according to claim 6, wherein the control unit acquires from the application apparatus a device list of the devices associated with the application apparatus, and, based on the device list, makes a request, to the server apparatus, for access information for the information processing apparatus to connect to the devices to acquire the access information.

9. The information processing apparatus according to claim 7, wherein the application apparatus transmits the device list to the information processing apparatus, based on the access information, acquired from the server apparatus, for the application apparatus to connect.

10. The information processing apparatus according to claim 1, wherein access information for the information processing apparatus to connect to the device includes data pipeline identification information for identifying a data pipeline.

11. The information processing apparatus according to claim 1, wherein access information for the application apparatus to connect to the device associated with the application apparatus includes data pipeline identification information for identifying a data pipeline.

12. The information processing apparatus according to claim 1, wherein the control unit acquires operation instruction information including apparatus identification information for identifying the application apparatus or data pipeline identification information for identifying a data pipeline, and determines a destination of the data, based on the acquired operation instruction information.

13. The information processing apparatus according to claim 1, wherein the control unit acquires operation instruction information, determines a destination of the data, based on operation instruction identification information for identifying the operation instruction information included in the data acquired from the device, and transmits the data to one or more of the application apparatuses determined as the destination.

14. The information processing apparatus according to claim 1, wherein the information processing apparatus is Data Service of the NICE standard.

15. An information processing method comprising: by an information processing apparatus,
acquiring, for a plurality of application apparatuses, association information between a device that outputs data and each of the application apparatuses that performs predetermined data processing using the data; determining a destination of the data acquired from one or more of the devices, based on the acquired association information; and transmitting the data to one or more of the application apparatuses determined as the destination.

16. A computer-readable recording medium having stored thereon a program for causing a computer to execute processing of:
acquiring, for a plurality of application apparatuses, association information between a device that outputs data and each of the application apparatuses that performs predetermined data processing using the data; determining a destination of the data acquired from one or more of the devices, based on the acquired association information; and transmitting the data to one or more of the application apparatuses determined as the destination.

17. An information processing apparatus comprising: a control unit that controls transmission of at least one identifier for identifying a role of a TLS client or a TLS server and a TLS certificate in accordance with the identifier, to two entities that communicate data generated by a device.

18. The information processing apparatus according to claim 17, wherein the two entities perform TLS mutual authentication using the TLS certificate transmitted from the information processing apparatus.

19. The information processing apparatus according to claim 17, wherein the control unit controls transmission of two identifiers for identifying a role of a TLS client and a role of a TLS server, and a TLS client certificate and a TLS server certificate, to each of the two entities.

20. The information processing apparatus according to claim 17, wherein the identifier and the TLS certificate are included in a SceneMode object and transmitted.

21. The information processing apparatus according to claim 17, wherein the identifier and the TLS certificate are included in an EndPoint property of a SceneMode object and transmitted.

22. The information processing apparatus according to claim 17, wherein the information processing apparatus is Data Pipeline Controller of the NICE standard.

23. The information processing apparatus according to claim 17, wherein at least one of the two entities is a device of the NICE standard.

24. The information processing apparatus according to claim 17, wherein the two entities are devices of the NICE standard.

25. The information processing apparatus according to claim 17, wherein the control unit acquires a TLS client certificate and a TLS server certificate that are issued by a management server, and controls transmission of the certificates to the two entities, respectively.

26. The information processing apparatus according to claim 25, wherein the management server is NICE AS of the NICE standard.

27. An information processing method comprising: by an information processing apparatus,
transmitting at least one identifier for identifying a role of a TLS client or a TLS server and a TLS certificate in accordance with the identifier to two entities that communicate data generated by a device.

28. A computer-readable recording medium having stored thereon a program for causing a computer to execute processing of:
transmitting at least one identifier for identifying a role of a TLS client or a TLS server and a TLS certificate in accordance with the identifier to two entities that communicate data generated by a device.
